(19) United States
(12) Patent Application Publication
(10) Pub. No.: US 2023/0013661 A1
(43) Pub. Date: Jan. 19, 2023

(54) PIXEL CIRCUIT WITH THRESHOLD VOLTAGE COMPENSATION

(71) Applicant: Sharp Display Technology Corporation, Kameyama City (JP)

(72) Inventors: OLIVER JAMES BEARD, Oxford (GB); KOHHEI TANAKA, Kameyama City (JP)

(21) Appl. No.: 17/376,519

(22) Filed: Jul. 15, 2021

(51) Int. Cl. G09G 3/3233

(52) U.S. Cl. CPC G09G 3/3233; G09G 2320/0233; G09G 2300/043; G09G 2300/0842; G09G 2300/0819

(57) ABSTRACT

A pixel circuit for a display device is disclosed. The pixel circuit may include a drive transistor configured to control an amount of current from a first power supply to a light-emitting device depending upon a voltage applied to a gate of the drive transistor. The light-emitting device includes a first terminal electrically connected to a second terminal of the drive transistor and a second terminal electrically connected to a second power supply. The pixel circuit may also include a storage capacitor including a first plate connected to the gate terminal of the drive transistor and a second plate connected to a first node. The pixel circuit may also include a plurality of transistors configured to couple the first power supply, a data voltage input line, and a preset voltage input line to the pixel circuit.

### FIELD

The present disclosure generally relates to electronic circuits, and in particular relates to control circuits for pixels of a display device, such as to deliver electrical current to an organic light-emitting diode (OLED) in a pixel of an active-matrix OLED (AMOLED) display device.

### BACKGROUND

OLEDs generate light by recombination of electrons and holes. More specifically, OLEDs emit light when a bias is applied between the anode and cathode of the OLED such that electrical current passes between them. The brightness of the light is related to the amount of the current. If there is no current, there will be no light emission. As such, the OLED technology is a type of technology that is capable of absolute blacks that could achieve virtually infinite contrast ratio between pixels when used in display applications.

Conventionally, pixel thin-film transistor (TFT) circuits deliver current to an element of a display device, such as an OLED, through a drive transistor. In one example, an input signal, such as a high “SCAN” signal, may be provided to a switch transistor in the circuit to permit a voltage of a data voltage input line “VDAT” to be stored at a storage capacitor during a programming phase of the circuit. When the SCAN signal is low and the switch transistor isolates the circuit from the data voltage, the VDAT voltage (V_{DAT}) is retained by the capacitor, and this voltage is applied to a gate of the drive transistor. With the drive transistor having a threshold voltage VTH, the amount of current to the OLED (I_{OLED}) is related to the voltage on the gate of the drive transistor by way of the electrical current gain, or “beta,” of the drive transistor, given by the following equation (where V_{OLED} is the voltage across the OLED):

$${I}_{OLED} = \frac{β}{2} {( {V}_{DAT} - {V}_{OLED} - {V}_{TH} )}^{2}$$

TFT device characteristics, especially the TFT threshold voltage V_{TH}, may vary due to manufacturing processes and/or stress and aging of the TFT device during operation. With the same VDAT voltage, the amount of current delivered by the TFT drive transistor could vary by a large amount due to such threshold voltage variations from pixel to pixel. Therefore, pixels in a display may not exhibit uniform brightness for a given VDAT value. Similarly, OLED device characteristics may vary due to manufacturing processes and/or stress and aging during operation of the OLED. For example, the threshold voltage of the OLED for light emission may change. Conventional circuit configurations, therefore, often include elements that operate to compensate for at least some of these component variations to achieve an OLED display with more uniform brightness among sub-pixels.

Conventionally, therefore, OLED pixel circuits have high tolerance ranges to variations in threshold voltage and/or carrier mobility of the drive transistor by employing circuits that compensate for mismatch in the properties of the drive transistors. However, such circuits often create undesired issues, such as unfavorable light emissions (e.g., compromised contrast ratio), reduced transistor drive current accuracy, poor power efficiency, enlarged circuit footprint, slow or ineffective threshold compensation, and the like.

Additionally, complicating threshold voltage compensation efforts is a growing desire for low-frequency driving of the drive transistor to reduce power consumption, as such driving may cause additional issues. One such issue is drive transistor hysteresis, whereby the transistor threshold voltage may vary depending on the magnitude of the voltages applied to the gate and source of the drive transistor in the previous frames, which could lead to unpredictable and variable emission levels from pixels that depend on the history of the pixel and not just the applied data voltage.

### SUMMARY

The present disclosure is directed to a pixel circuit that compensates for threshold voltage variations in a drive transistor.

In accordance with one aspect of the present disclosure, a pixel circuit may include a drive transistor including a gate terminal, a first terminal, and a second terminal. The drive transistor may be configured to control an amount of current from a first power supply to a light-emitting device depending upon a voltage input applied to the gate terminal of the drive transistor. The light-emitting device may include a first terminal electrically connected to the second terminal of the drive transistor and a second terminal electrically connected to a second power supply. The pixel circuit may further include a storage capacitor including a first plate connected to the gate terminal of the drive transistor and a second plate connected to a first node. The pixel circuit may further include a first transistor including a first terminal connected to the first power supply and a second terminal connected to the first terminal of the drive transistor. The pixel circuit may further include a second transistor including a first terminal connected to the first terminal of the drive transistor and a second terminal connected to the gate terminal of the drive transistor. The pixel circuit may further include a third transistor including a first terminal connected to the first node and a second terminal connected to a data voltage input line. The pixel circuit may further include a fourth transistor including a first terminal connected to the second terminal of the drive transistor and a second terminal connected to a preset voltage input line. The pixel circuit may further include a fifth transistor including a first terminal connected to the first node and a second terminal connected to the second terminal of the drive transistor.

In an implementation of the first aspect, the pixel circuit may further include a second storage capacitor including a first plate connected to the gate terminal of the drive transistor and a second plate connected to the second terminal of the drive transistor.

In another implementation of the first aspect, the pixel circuit may further include a sixth transistor including a first terminal connected to the second terminal of the drive transistor, and a second terminal connected to the first terminal of the fourth transistor, the second terminal of the fifth transistor, and the first terminal of the light-emitting device.

In another implementation of the first aspect, the pixel circuit may further include a sixth transistor including a first terminal connected to the first terminal of the drive transistor, and a second terminal connected to the second terminal of the first transistor and the first terminal of the second transistor.

In another implementation of the first aspect, the pixel circuit may further include a stabilizing capacitor including a first plate connected to the first terminal of the second transistor and a second plate connected to a stabilization voltage input line.

In another implementation of the first aspect, the pixel circuit may further include a reference transistor including a first terminal connected to the second terminal of the drive transistor and a second terminal connected to a reference voltage input line.

In another implementation of the first aspect, the pixel circuit may further include a separation transistor including a first terminal connected to the first terminal of the fourth transistor and the second terminal of the fifth transistor, and a second terminal connected to the first terminal of the light-emitting device, where, in an off state, the separation transistor isolates the light-emitting device from a remainder of the pixel circuit.

In another implementation of the first aspect, the drive transistor, the first transistor, the second transistor, the third transistor, the fourth transistor, and the fifth transistor include n-type transistors.

In another implementation of the first aspect, at least one of the drive transistor, the first transistor, the second transistor, the third transistor, the fourth transistor, or the fifth transistor includes an indium gallium zinc oxide (IGZO) transistor.

In another implementation of the first aspect, the light-emitting device includes one of an organic light-emitting diode (OLED), a micro light-emitting diode (micro LED), or a quantum dot LED (QLED).

In accordance with a second aspect of the present disclosure, a method of operating a pixel circuit for a display device in a normal mode may include providing a pixel circuit. The pixel circuit may include a drive transistor including a gate terminal, a first terminal, and a second terminal. The drive transistor may be configured to control an amount of current from a first power supply to a light-emitting device depending upon a voltage input applied to the gate terminal of the drive transistor. The light-emitting device may include a first terminal electrically connected to the second terminal of the drive transistor and a second terminal electrically connected to a second power supply. The pixel circuit may further include a storage capacitor including a first plate connected to the gate terminal of the drive transistor and a second plate connected to a first node. The pixel circuit may further include a plurality of transistors, each of the plurality of transistors coupled to one or more of the drive transistor, the light-emitting device, and the storage capacitor. The method, using one or more of the plurality of transistors, may perform an initialization phase including setting at least the gate terminal of the drive transistor to a first voltage without turning the drive transistor on by electrically connecting at least the gate terminal of the drive transistor to the first power supply. The method, using one or more of the plurality of transistors, may further perform a combined threshold compensation and data programming phase to compensate a threshold voltage of the drive transistor and program a data voltage to the pixel circuit by diode-connecting the drive transistor by electrically connecting the first terminal and the gate terminal of the drive transistor, electrically disconnecting the first power supply from the diode-connected drive transistor, electrically disconnecting the second terminal of the drive transistor from the first node, electrically connecting the second terminal of the drive transistor to a preset voltage input line, and electrically connecting a data voltage input line to the second plate of the storage capacitor at the first node. The method, using one or more of the plurality of transistors, may further perform a continued threshold compensation phase to continue compensating the threshold voltage of the drive transistor without the data voltage input line being connected to the pixel circuit by electrically disconnecting the data voltage input line from the second plate of the storage capacitor without changing any other connections from the combined threshold compensation and data programming phase. The method, using one or more of the plurality of transistors, may further perform an emission phase during which light is emitted from the light-emitting device by electrically disconnecting the preset voltage input line from the drive transistor, electrically disconnecting the diode-connection of the drive transistor, electrically connecting the first node to the second terminal of the drive transistor, and electrically connecting the first terminal of the drive transistor to the first power supply.

In an implementation of the second aspect, the method may further include electrically disconnecting the second terminal of the drive transistor from the first terminal of the light-emitting device prior to the initialization phase. Also in this implementation, the method may further include electrically connecting the second terminal of the drive transistor to the first terminal of the light-emitting device after the initialization phase and prior to the combined threshold compensation and data programming phase.

In another implementation of the second aspect, the method may further include electrically disconnecting the first terminal of the drive transistor from the first power supply at an end of the emission phase and before the initialization phase. Also in this implementation, the method may further include electrically connecting the first terminal of the drive transistor to the first power supply after the initialization phase and prior to the combined threshold compensation and data programming phase.

In another implementation of the second aspect, the method may further include electrically connecting the second terminal of the drive transistor to a reference voltage input line after the continued threshold compensation phase, and electrically disconnecting the second terminal of the drive transistor from the reference voltage input line during the emission phase.

In another implementation of the second aspect, the pixel circuit may further include a stabilizing capacitor including a first plate connected to the first terminal of the drive transistor and a second plate connected to a stabilization voltage input line.

In another implementation of the second aspect, the method may further include electrically disconnecting the first terminal of the light-emitting device from a remainder of the pixel circuit during the continued threshold compensation phase, and electrically connecting the first terminal of the light-emitting device to the second terminal of the drive transistor during the emission phase.

In another implementation of the second aspect, the pixel circuit may further include a second storage capacitor including a first plate connected to the gate terminal of the drive transistor and a second plate connected to the second terminal of the drive transistor.

In accordance with a third aspect of the present disclosure, a method of operating a pixel circuit for a display device in a low-frequency mode may include providing a pixel circuit. The pixel circuit may include a drive transistor including a gate terminal, a first terminal, and a second terminal. The drive transistor may be configured to control an amount of current from a first power supply to a light-emitting device depending upon a voltage input applied to the gate terminal of the drive transistor. The light-emitting device may include a first terminal electrically connected to the second terminal of the drive transistor and a second terminal electrically connected to a second power supply. The pixel circuit may further include a storage capacitor including a first plate connected to the gate terminal of the drive transistor and a second plate connected to a first node. The pixel circuit may further include a plurality of transistors, each of the plurality of transistors coupled to one or more of the drive transistor, the light-emitting device, and the storage capacitor. The method, using one or more of the plurality of transistors, may perform an anode reset phase by electrically connecting a data voltage input line or a preset voltage input line to the second plate of the storage capacitor and the first terminal of the light-emitting device. The method, using one or more of the plurality of transistors, may further perform an on-bias stress phase by electrically disconnecting the first terminal of the drive transistor from the first power supply, electrically disconnecting the second terminal of the drive transistor from the first node, electrically disconnecting the first node from the data voltage input line, and electrically connecting the second terminal of the drive transistor to the preset voltage input line. The method, using one or more of the plurality of transistors, may further perform an emission phase by electrically disconnecting the second terminal of the drive transistor from the preset voltage input line, electrically connecting the second terminal of the drive transistor to the first node, and electrically connecting the first terminal of the drive transistor to the first power supply.

In an implementation of the third aspect, the method may further include electrically disconnecting the second terminal of the drive transistor from the first node before the anode reset phase, electrically disconnecting the first terminal of the light-emitting device from a remainder of the pixel circuit before the on-bias stress phase, and electrically connecting the first terminal of the light-emitting device to the second terminal of the drive transistor after the on-bias stress phase and before the emission phase.

### BRIEF DESCRIPTION OF DRAWINGS

Aspects of the example disclosure are best understood from the following detailed description when read with the accompanying figures. Various features are not drawn to scale. Dimensions of various features may be arbitrarily increased or reduced for clarity of discussion.

FIG. 1 is a schematic diagram of a circuit configuration, in accordance with an example implementation of the present disclosure.

FIG. 2 is a timing diagram associated with a normal operational mode of the circuit configuration of FIG. 1, in accordance with an example implementation of the present disclosure.

FIG. 3 is a timing diagram associated with a low-frequency operational mode of the circuit configuration of FIG. 1, in accordance with an example implementation of the present disclosure.

FIG. 4 is a schematic diagram of another circuit configuration, in accordance with an example implementation of the present disclosure.

FIG. 5 is a schematic diagram of another circuit configuration, in accordance with an example implementation of the present disclosure.

FIG. 6 is a timing diagram associated with a normal operational mode of the circuit configuration of FIG. 5, in accordance with an example implementation of the present disclosure.

FIG. 7 is a schematic diagram of another circuit configuration, in accordance with an example implementation of the present disclosure.

FIG. 8 is a timing diagram associated with a normal operational mode of the circuit configuration of FIG. 7, in accordance with an example implementation of the present disclosure.

FIG. 9 is a schematic diagram of another circuit configuration, in accordance with an example implementation of the present disclosure.

FIG. 10 is a timing diagram associated with a normal operational mode of the circuit configuration of FIG. 9, in accordance with an example implementation of the present disclosure.

FIG. 11 is a schematic diagram of another circuit configuration, in accordance with an example implementation of the present disclosure.

FIG. 12 is a timing diagram associated with a normal operational mode of the circuit configuration of FIG. 11, in accordance with an example implementation of the present disclosure.

FIG. 13 is a schematic diagram of another circuit configuration, in accordance with an example implementation of the present disclosure.

FIG. 14 is a timing diagram associated with a normal operational mode of the circuit configuration of FIG. 13, in accordance with an example implementation of the present disclosure.

FIG. 15 is a timing diagram associated with a low-frequency operational mode of the circuit configuration of FIG. 13, in accordance with an example implementation of the present disclosure.

### DESCRIPTION

The following description contains specific information pertaining to exemplary implementations in the present disclosure. The drawings and their accompanying detailed description are directed to exemplary implementations. However, the present disclosure is not limited to these exemplary implementations. Other variations and implementations of the present disclosure will occur to those skilled in the art. Unless noted otherwise, like or corresponding elements in the figures may be indicated by like or corresponding reference numerals. Moreover, the drawings and illustrations are generally not to scale and are not intended to correspond to actual relative dimensions.

For consistency and ease of understanding, like features are identified (although, in some examples, not shown) by numerals in the exemplary figures. However, the features in different implementations may be different in other respects, and therefore will not be narrowly confined to what is shown in the figures.

The phrases “in one implementation” and “in some implementations” may each refer to one or more of the same or different implementations. The term “coupled” is defined as connected, whether directly or indirectly via intervening components, and is not necessarily limited to physical connections. The term “comprising” means “including, but not necessarily limited to” and specifically indicates open-ended inclusion or membership in the described combination, group, series, and equivalent.

Additionally, any two or more of the following paragraphs, (sub-)bullets, points, actions, behaviors, terms, alternatives, examples, or claims described in the following disclosure may be combined logically, reasonably, and properly to form a specific method. Any sentence, paragraph, (sub-)bullet, point, action, behavior, term, or claim described in the following disclosure may be implemented independently and separately to form a specific method. Dependency, e.g., “according to”, “more specifically”, “preferably”, “in one embodiment”, “in one implementation”, “in one alternative”, etc., in the following disclosure refers to just one possible example which would not restrict the specific method.

For explanation and non-limitation, specific details, such as functional entities, techniques, protocols, and standards, are set forth for providing an understanding of the described technology. In other examples, detailed description of well-known methods, technologies, systems, and architectures are omitted so as not to obscure the description with unnecessary details.

Also, while certain directional references (e.g., top, bottom, up, down, height, width, and so on) are employed in the description below and appended claims, such references are utilized to provide guidance regarding the positioning and dimensions of various elements relative to each other and are not intended to limit the orientation of the various embodiments to those explicitly discussed herein.

Various embodiments of pixel circuits, as described in greater detail below, may provide one or more of the following benefits: (1) quickly perform data programming with no dependence on the length of time needed for threshold voltage compensation, (2) compensate for the threshold voltage without reference to a variable parameter, (3) provide a constant gate-to-source voltage for a drive transistor regardless of the voltage biasing of the drive transistor source and drain terminals, and/or (4) reduce drive transistor hysteresis by applying a constant voltage at the gate and source terminals of the drive transistor for low-frequency operations.

The present disclosure relates to embodiments of pixel circuits that are capable of compensating threshold voltage variations of the drive transistor using a one-horizontal-time (labeled herein as “1H”) period (e.g., less than 3 μs), which is relatively short compared to compensation operations of conventional configurations. The data voltage used to produce an associated level of current through an OLED may be applied for a portion of the threshold compensation operation, and thus may persist for significantly less time than is required for the entire threshold compensation operation, with the data programming operation potentially taking place over a single 1H period and the entire threshold compensation operation potentially taking place over multiple 1H periods. The threshold compensation operation may sink charge to a constant voltage supply line rather than either a variable component parameter or the data voltage supply line, resulting in compensation across an array of pixels that may be repeatable. The programmed voltage may be connected between the gate and source of the drive transistor to ensure that if the transistor voltage bias changes, the same gate-source voltage will be applied regardless.

Embodiments of the present application may provide pixel circuits for high refresh rate requirements, such as for 120 Hz applications. For such applications, a short 1H time (e.g., <3 μs) may be achieved by only applying the data programming phase for a portion of threshold compensation of the drive transistor. The threshold compensation time is dictated by the drive transistor characteristics and is difficult to reduce further without degrading compensation accuracy. By only applying the data programming phase for a portion of the total threshold compensation phase, a longer time may be allocated to threshold compensation for compensation accuracy. As referenced above, the RC constant time required for charging the programming capacitor is determinative of the programming time, and such programming time can be reduced to short 1H times.

More specifically, in some embodiments, the data voltage may be applied to a lower plate of a capacitor, the upper plate of which is attached to the drive transistor gate. Accordingly, the data voltage may be written, and then removed, while compensation of the threshold continues. The data voltage will be retained at the lower plate of the capacitor, while any threshold compensation voltage components continue to be stored at the gate and the upper plate of the capacitor after removal of the data voltage. The compensation operation may be referenced to a different supply voltage than the data voltage. When the storage capacitor is connected between the source and gate terminals of the drive transistor after the programming and compensation operations have finished, the voltage across these terminals may relate only to (1) the data voltage, (2) the threshold voltage of the drive transistor, and (3) the separate supply voltage to which the threshold compensation operation sinks current, the last of which is constant to all pixels. If the voltage at the source of the drive transistor changes, the voltage at the gate will move by the same amount because of the capacitor coupling these two terminals. Consequently, consistent pixel output may be generated regardless of the source voltage, which may depend upon component aging or loading characteristics, such as the OLED “on” voltage.

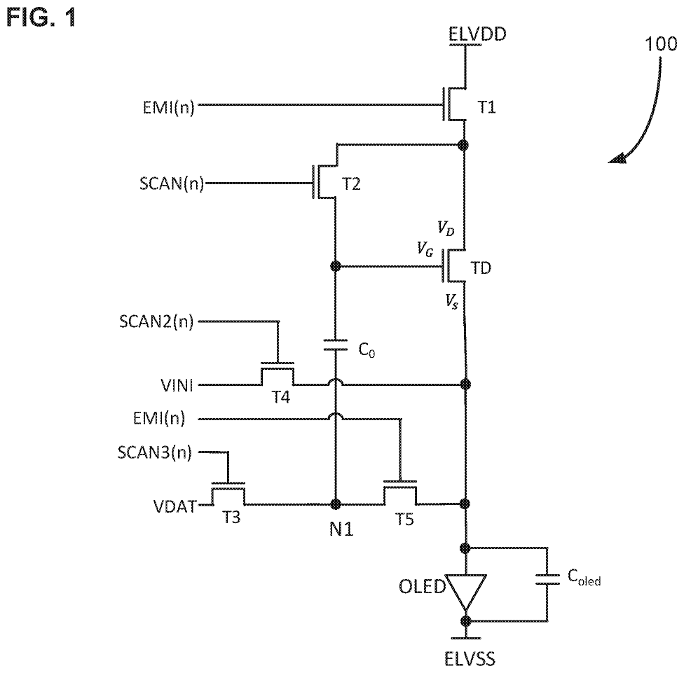

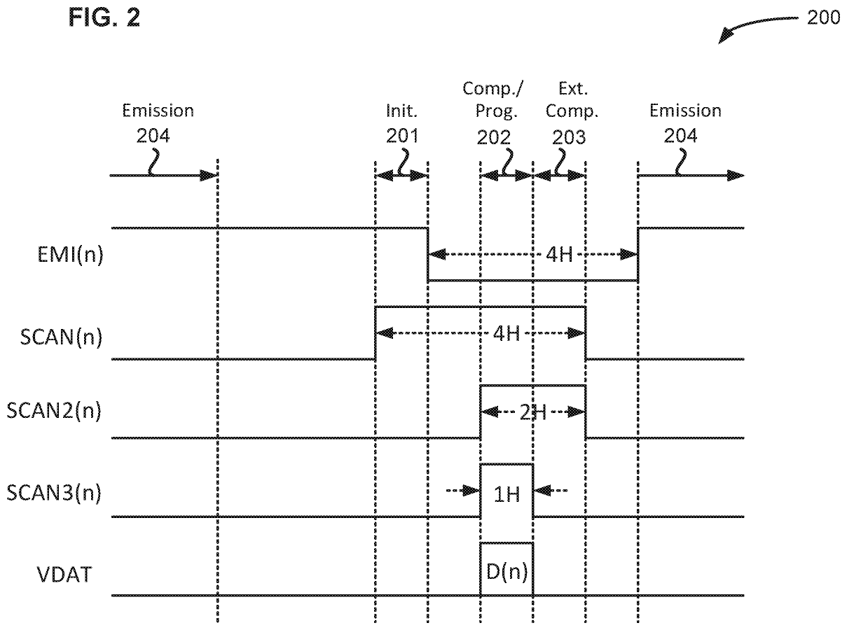

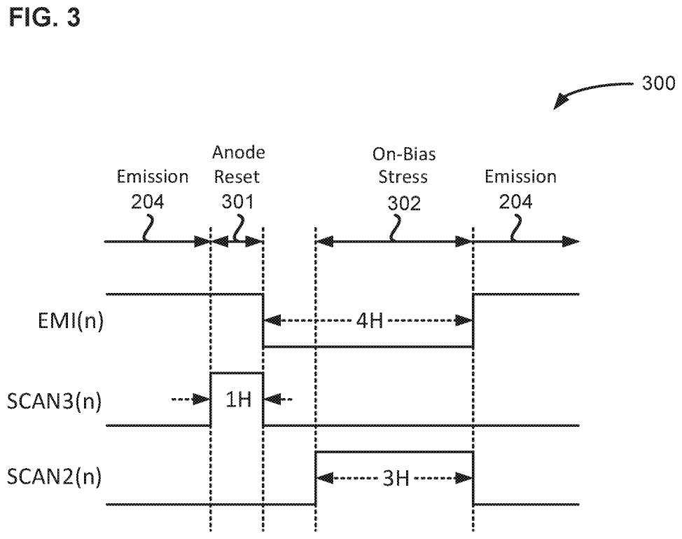

FIG. 1 is a schematic diagram depicting a circuit configuration 100 in accordance with embodiments of the present disclosure. FIG. 2 is a timing diagram associated with a normal operating mode 200 of circuit configuration 100 of FIG. 1. FIG. 3 is a timing diagram associated with a low-frequency operating mode 300 of circuit configuration 100. In the depicted examples, circuit configuration 100 may be a TFT circuit configuration that includes multiple n-type transistors TD and T1-T5, as well as a storage capacitor C₀. In other embodiments, multiple p-type transistors may instead be employed with minor changes to circuit configuration 100. The circuit elements drive a light-emitting device, such as an OLED. The OLED may have an associated internal capacitance, which is represented in the schematic as C_{oled}. In addition, although the embodiments are described principally in connection with an OLED as the light-emitting device, comparable principles may be used with display technologies that employ other types of light-emitting devices, including, for example, micro-LEDs and quantum dot LEDs (QLEDs). In the example of FIG. 1, power may be supplied to circuit configuration 100 by a first power supply ELVDD and a second power supply ELVSS.

FIG. 1 depicts circuit configuration 100 as including multiple n-MOS or n-type TFTs. More specifically, circuit configuration 100 includes a drive transistor TD (e.g., an analogue TFT) and digital switch transistors T1-T5 (e.g., digital switch TFTs). In FIG. 1 and subsequent figures, the terminals (and associated voltages) of drive transistor TD are labeled gate (V_{G}), source (V_{S}, and drain (V_{D}). As referenced above, C₀ is a storage capacitor, and C_{oled} is the internal capacitance of the OLED device (e.g., C_{oled} may not be a separate component, but may be inherent to the OLED). The OLED may further be connected to second power supply ELVSS, as is conventional.

In some embodiments, low-leakage transistors, such as IGZO (indium gallium zinc oxide) transistors, may be used for some or all of switch transistors T1-T5 (as well as other switch transistors described herein) connected to respective voltage supply lines. By using low-leakage transistors, either a smaller storage capacitor C₀ may be employed to reduce the pixel size, or a low refresh rate, such as 30 Hz or lower, may be used to better display static or low-motion images. Power consumption may thus be reduced in some embodiments. Also, in some embodiments, drive transistor TD may be an IGZO transistor.

The OLED and circuit configuration 100, including transistors TD and T1-T5, storage capacitor C₀, and connecting wires, may be fabricated using conventional TFT fabrication processes. It will be appreciated that comparable fabrication processes may be employed to fabricate the TFT circuits according to any of the embodiments described above and below.

For example, circuit configuration 100 (and subsequent embodiments) may be disposed on a substrate, such as a glass, plastic, or metal substrate. Each TFT TD and T1-T5 may include a gate electrode, a gate insulating layer, a semiconducting layer, a first electrode, and a second electrode. The semiconducting layer may be disposed on the substrate. The gate insulating layer may be disposed on the semiconducting layer, and the gate electrode may be disposed on the insulating layer. The first electrode and second electrode may be disposed on the insulating layer and connected to the semiconducting layer using vias. The first electrode and second electrode may commonly be referred to as the “source electrode” and “drain electrode,” respectively, of TFTs TD and T1-T5. Storage capacitor Co may comprise a first electrode connected to a first plate, an insulating layer, and a second electrode connected to a second plate, whereby the insulating layer may form an insulating barrier between the first and second plates. Wiring between components in the circuit, and wiring used to introduce signals to the circuit (e.g., a SCAN signal, an EMI (emission) signal, a VDAT (data voltage) signal, and a VINI (initialization voltage) input line) may comprise metal lines or a doped semiconductor material. For example, metal lines may be disposed between the substrate and the gate electrode of a TFT and connected to electrodes using vias. The semiconductor layer may be deposited by chemical vapor deposition, and metal layers may be deposited by a thermal evaporation technique.

The OLED device may be disposed over TFT circuit configuration 100. The OLED device may include a first electrode (e.g., an anode of the OLED), which may be connected to transistors TD, T4, and T5 in this example. The OLED device may also include one or more layers for injecting or transporting charge (e.g., holes) to an emission layer, the emission layer, one or more layers for injecting or transporting electrical charge (e.g., electrons) to the emission layer, and a second electrode (e.g., a cathode of the OLED), which may be connected to second power supply ELVSS in this example. In some embodiments, the injection layers, transport layers, and emission layer may include organic materials, the first and second electrodes may be metals, and all of these layers may be deposited by a thermal evaporation technique.

In some embodiments, a display device may include multiple OLEDs and associated pixel circuits (e.g., circuit configuration 100) that are arranged in rows, with the OLEDs in a particular row being provided with data for the current video frame simultaneously. Further, in some examples, the frame data for each row of OLEDs may be updated in order, from top to bottom, before starting at the top row again for the next frame. In such an arrangement, circuit configuration 100 for pixels in a particular row may be controlled using control signals EMI, SCAN, and their complementary signals (e.g., EMIB and SCANB) that are employed for other rows of pixels, thereby enabling fewer control signal wires in a display configuration, as common control lines may be shared by different rows. For this example and in subsequent embodiments, display pixels are addressed by row and column. The current row is row n. The previous row is row n−1, and the second previous row is row n−2. The next row after the current row is row n+1, and the row after that is row n+2, and so on for the various rows as they relate to the corresponding control signals identified in the figures. Accordingly, for example, SCAN(n) refers to the scan signal at row n and SCAN(n+1) refers to the scan signal at row n+1, and the like. EMI(n) refers to the emission signal at row n and EMI(n−1) refers to the emission signal at row n−1, and the like, and so on for the various control signals. In this manner, for the various embodiments, the input signals correspond to the indicated rows.

Circuit configuration 100, as well as at least some other circuit configurations described below, may operate in two modes: a normal operating mode and a low-frequency operating mode. For normal operating mode 200, as depicted in FIG. 2, the pixel operates using full cycles, which may include an initialization phase 201, a combined threshold compensation and data programming phase 202, a continued or extended threshold compensation phase 203, and an emission phase 204 for light emission.

For low-frequency operating mode 300, the pixel may first operate a full normal mode 200 cycle, as shown in FIG. 2, to program the data voltage to the pixel, which may be defined as a refresh frame. Thereafter, the pixel may operate using a reduced number of control signals (e.g., emission control signal EMI(n), along with scanning control signals SCAN2(n) and SCAN3(n) only), as illustrated in FIG. 3, during low-frequency mode 300. A time period between successive emission phases 204 may include an anode reset phase 301, during which the anode of the OLED is reset, and an on-bias stress phase 302, during which stress is applied to the gate and source of drive transistor TD to reduce hysteresis. These phases of low-frequency operating mode 300 may be defined as a non-refresh frame, which is described in greater detail below in conjunction with FIG. 3. In some embodiments, power consumption may be reduced during the non-refresh frame without initialization phase 201, combined threshold compensation and data programming phase 202, and extended threshold compensation phase 203.

Referring to circuit configuration 100 of FIG. 1, in combination with the timing diagram of FIG. 2, in some embodiments, during a previous emission phase 204, emission signal EMI(n) may have a (relative) high voltage value, such that transistors T1 and T5 are “on,” or closed. With transistor T1 being on, light emission is driven by way of transistor T1 connecting first power supply ELVDD to drive transistor TD, whereby the actual current applied to the OLED is determined by the voltage across the gate and source of drive transistor TD. With transistor T5 on, the bottom plate of storage capacitor C₀ is connected to the source terminal of drive transistor TD. Storage capacitor C₀ is therefore connected between the gate and source terminals of drive transistor TD while transistor T5 is on, and the charge stored thereon may determine how much current is drawn by drive transistor TD. The signal levels of control signals SCAN(n), SCAN2(n), and SCAN3(n) may initially possess low voltage values such that transistors T2, T3, and T4 are “off,” or open.

At the beginning of initialization phase 201, as depicted in FIG. 2, the voltage level of control signal SCAN(n) is changed from a low voltage value to a high voltage value, causing transistor T2 to turn on. With transistor T2 on, both the drain and gate terminals of drive transistor TD become connected to first supply voltage ELVDD supply through transistors T1 and T2. In addition, transistors T1 and T2 are operating as digital switches, so a substantially insignificant current is drawn by each such that the voltage level applied to the gate terminal of drive transistor TD is approximately the same as first supply voltage ELVDD.

In some embodiments, initialization phase 201 causes memory effects from the previous frame to be cleared from circuit configuration 100, and particularly from the gate terminal of drive transistor TD. Because none of the control signals employed in this operation (e.g., particularly control signal SCAN(n)) are linked to data writing operations described below, the desired speed at which the video data is to be written to the display panel is not determined by the time required to perform initialization phase 201. Accordingly, the speed of initialization phase 201 does not limit the speed of the writing of video data, thus facilitating the use of fast 1H times.

Next, at the end of initialization phase 201, the signal level of emission control signal EMI(n) may be changed from a high voltage value to a low voltage value, causing transistors T1 and T5 to turn off. With transistor T1 off, the diode-connected gate and drain terminals of drive transistor TD become disconnected from first power supply voltage ELVDD and are thus electrically “floating,” or not actively driven to a particular voltage. With transistor T5 off, the lower plate of capacitor C₀, also referred to as a first node N1, is disconnected from the source terminal of drive transistor TD, thus electrically floating the lower plate of capacitor C₀. Thus, at the end of initialization phase 201, drive transistor TD is held in the off state, with none of its terminals driven to a constant voltage potential. Further, the charge on storage capacitor C₀ and the voltages of the various circuit nodes of circuit configuration 100 do not significantly change as a result of transistors T1 and T5 turning off.

The end of initialization phase 201 and the start of combined threshold compensation and data programming phase 202 may occur at the same time, or a delay may be inserted therebetween (e.g., as depicted in FIG. 2). In at least some embodiments, control signal EMI(n) may reach a low voltage level, thus turning off transistors T1 and T5, before control signals SCAN2(n) and SCAN3(n) turn on transistors T3 and T4; otherwise, the threshold compensation operation described below may possess inaccuracies. For example, if control signal EMI(n) possesses a slower fall time (e.g., from a high voltage level to a low voltage level) than the rise time of control signals SCAN2(n) and SCAN3(n), inserting a gap between the end of initialization phase 201 and the start of combined threshold compensation and data programming phase 202 may be desired. During this gap, charge may flow from storage capacitor C₀ into the OLED through drive transistor TD, reducing the gate and drain voltages of drive transistor TD and essentially starting the compensation operation prior to combined threshold compensation and data programming phase 202. However, this operation may be significantly slower than during combined threshold compensation and data programming phase 202 and continued threshold compensation phase 203, and thus may not lead to significant emission from the OLED, as capacitance C_{oled} will not be filled quickly enough. In some embodiments, the duration of this gap may be minimized to prevent the voltages applied to drive transistor TD from changing excessively during the gap.

Next, at the start of combined threshold compensation and data programming phase 202, the signal levels of control signals SCAN2(n) and SCAN3(n) may be changed from a low voltage value to a high voltage value, thus causing transistors T3 and T4 to turn on. With transistor T3 turned on, first node N1 is connected to data voltage input line VDAT. Data voltage input line VDAT may have changed from a data value associated with another pixel (e.g., the previous row of the display VDAT(n−1)) to the data value associated with the current pixel (e.g., the current row of the display VDAT(n)) prior to the start of combined threshold compensation and data programming phase 202 such that the correct data voltage for that pixel is applied to the second plate of storage capacitor C₀. Capacitor C₀ may therefore charge or discharge until first node N1 is charged to the correct data voltage. With transistor T4 turned on, the source of drive transistor TD and the anode of the OLED are connected to initialization voltage input line VINI, resulting in the voltage across the OLED becoming initialization voltage VINI minus second power supply voltage ELVSS. This operation thus resets the OLED to a common voltage potential and discharges parasitic capacitor C_{oled} to a constant value on each display frame. This operation will remove any memory effects from the previous emission state of the pixel. To prevent the OLED from emitting light while transistor T4 is on, the value of initialization voltage input line VINI may be chosen according to the following relationship.

V_{INI}−V_{ELVSS}<V_{th,oled}

In the above relationship, V_{th,oled} is the threshold voltage of the OLED, above which the OLED will begin emitting light. In some embodiments, initialization voltage input line VINI may be set to equal second power supply voltage ELVSS so that no voltage potential is exerted on the OLED during this period to avoid any effect this operation may have on the lifetime or performance of the OLED.

During combined threshold compensation and data programming phase 202, the source terminal of drive transistor TD may be electrically connected to initialization voltage input line, VINI, through transistor T4. As the drain and gate terminals of drive transistor TD are diode-connected through transistor T2, the voltage level of the drain and gate terminals may drop from first power supply voltage ELVDD toward the lower voltage of initialization voltage input line VINI.

In some embodiments, to provide effective threshold voltage compensation of drive transistor TD, the voltage at the source terminal of drive transistor TD (initialization voltage input line VINI) may satisfy the following condition:

V_{ELVDD}−V_{INI}>ΔV+V_{TH}

In the above relationship, V_{TH} is the threshold voltage of drive transistor TD, and ΔV is a voltage large enough to generate a high initial current to charge capacitor C₀ within an allocated threshold compensation time. In at least some embodiments, the value of ΔV may depend on the properties of drive transistor TD. For example, ΔV may be at least 3 volts in an example low-temperature polycrystalline silicon thin-film transistor process. Consequently, initialization voltage input line VINI may be set to satisfy the following voltage relationship:

V_{INI}<V_{ELVDD}−ΔV−V_{TH}

Thereafter, at the end of combined threshold compensation and data programming phase 202, the signal level of control signal SCAN3(n) may be changed from a high voltage value to a low voltage value, thus causing transistor T3 to turn off. With transistor T3 off, the bottom plate of storage capacitor C₀ is disconnected from data voltage input line VDAT. First node N1 may now be set to the voltage of data voltage input line VDAT. Compensation of drive transistor TD may not have finished by this point, so the diode-connected gate and drain terminals of drive transistor TD may still be changing voltage. Data voltage input line VDAT may then change from the data value for the current row, VDAT(n), to the data value for the next row, VDAT(n+1). Consequently, the length of combined threshold compensation and data programming phase 202 may determine the 1H time, and therefore the overall speed, of the display system.

Continued threshold compensation phase 203 may begin at this point in some embodiments. During this phase, the gate and drain terminals of drive transistor TD may continue to decrease. As first node N1 is floating and will have the charge from combined threshold compensation and data programming phase 202 stored thereat, first node N1 may change voltage potential at the same rate as the gate and drain terminals of drive transistor TD. At the end of continued threshold compensation phase 203, no current may be flowing from the gate and drain terminals of drive transistor TD to the source terminal of drive transistor TD. The voltage at the gate and drain terminals of drive transistor TD, which is also the voltage of the top plate of storage capacitor C₀, becomes the sum of initialization voltage input line VINI and the threshold voltage V_{TH} of drive transistor TD, as shown below:

V_{G}=V_{S}−V_{INI}+V_{TH}

At the end of continued threshold compensation phase 203, control signals SCAN(n) and SCAN2(n) change from a high voltage value to a low voltage value, causing transistors T2 and T4 to turn off. As transistor T2 is turned off, the gate and drain terminals of drive transistor TD are disconnected, and drive transistor TD is no longer diode-connected. As transistor T4 is turned off, the source terminal of drive transistor TD is disconnected from initialization voltage input line VINI.

Circuit configuration 100 may then be operated in emission phase 204, during which the OLED is capable of emitting light with a driving voltage input being supplied from first power supply voltage ELVDD through transistor T1. At the beginning of emission phase 204, control signal EMI(n) signal is changed from a low voltage value to a high voltage value, causing transistors T1 and T5 to turn on. With transistor T1 turned on, first power supply voltage ELVDD is supplied to the drain terminal of drive transistor TD. With transistor T5 turned on, first node N1, connected to the lower plate of storage capacitor C₀, is connected to the source terminal of drive transistor TD.

After reaching emission phase 204, where storage capacitor Co is connected between the gate and source terminals of drive transistor TD, if the voltage at the anode of the OLED is V_{OLED}, the voltage at the gate terminal of drive transistor TD, where the upper plate of storage capacitor C₀ is connected, may be described as follows:

V_{OLED}+V_{C0}=V_{OLED}+(V_{INI}+V_{TH}−(V_{DAT}+ΔV_{A}))

In the above equation, any parasitic capacitances that may slightly alter the effective size of storage capacitor C₀ are presumed sufficiently small to be ignored. Also, ΔV_{A} represents the change in the voltage of the lower plate of storage capacitor C₀ between the end of combined threshold compensation and data programming phase 202 and the end of continued threshold compensation phase 203. In some embodiments, ΔV_{A} is likely to be relatively small and substantially similar between different pixels, regardless of the size of V_{TH} in the pixel. Consequently, ΔV_{A} may be considered a small additional voltage offset in this term.

The current that flows through the OLED is therefore:

$${I}_{OLED} = \frac{β}{2} {( ( {V}_{INI} + {V}_{TH} - ( {V}_{DAT} + Δ {V}_{A} ) ) - {V}_{TH} )}^{2} = \frac{β}{2} {( {V}_{INI} - {V}_{DAT} - Δ {V}_{A} )}^{2}$$

In the above equation,

$$β = {μ}_{n} \cdot {C}_{ox} \cdot \frac{W}{L}$$

is the electrical current gain, or “beta,” of drive transistor TD, where Cₒₓ is the capacitance of the gate oxide of drive transistor TD, W is the width of the channel of drive transistor TD, L is the length of the channel of drive transistor TD (i.e., the distance between the source and drain terminals), and μₙ is the carrier mobility of drive transistor TD.

Accordingly, the current to the OLED does not depend on the threshold voltage V_{TH} of the transistor TD and the voltage variations of the OLED. In this manner, variation in the threshold voltage V_{TH} of drive transistor TD and the voltage variations of the OLED have been compensated.

In addition, by using IGZO transistor devices (e.g., transistors T1-T5) as switches, the leakage from storage capacitor C₀ may be greatly reduced. In particular, with transistor T2 operating as a switch between the gate and drain terminals of drive transistor TD, the leakage from the upper plate of storage capacitor C₀ to the drain terminal of drive transistor TD may be reduced. With transistor T3 operating as a switch between data input voltage line VDAT and the lower plate of storage capacitor C₀ at first node N1, the leakage from the lower plate of storage capacitor C₀ to data input voltage line VDAT is reduced. With transistor T4 operating as a switch between initialization voltage input line VINI and the source terminal of IGZO drive transistor TD, the leakage from the lower plate of storage capacitor C₀ to initialization voltage input line VINI is reduced. Hence, the voltages stored on storage capacitor C₀ may be retained for a longer time compared to embodiments in which other types of transistors are employed. As a result, as referenced above, the refresh rate may be reduced as compared to conventional configurations, down to about 30 Hz or lower, which is particularly suitable for displaying static images, for example.

If circuit configuration 100 continues to operate in normal mode 200 (e.g., the refresh frame), as described above in conjunction with FIG. 2, the operation will repeat the above initialization phase 201, combined threshold compensation and data programming phase 202, continued threshold compensation phase 203, and emission phase 204. If, instead, circuit configuration 100 begins to operate in low-frequency mode 300 after normal mode 200, only control signals EMI(n), SCAN2(n), and SCAN3(n) may change state during low-frequency mode 300 (e.g., the non-refresh frame), as mentioned above.

FIG. 3 is a timing diagram associated with the operation of low-frequency mode 300 (or the non-refresh frame) of circuit configuration 100 of FIG. 1. During a previous emission phase 204, control signal EMI(n) has a high voltage value, so transistor T1 is on, and light emission is driven by first power supply voltage ELVDD connected to drive transistor TD, whereby the actual current applied to the OLED is determined by the voltage at the gate terminal of drive transistor TD. Transistor T5 is also in an on state and is connecting storage capacitor C₀ between the gate and source terminals of drive transistor TD to apply a constant gate-source voltage. Control signals SCAN2(n) and SCAN3(n) for the current row n initially have a low voltage value, so transistors T2-T4 are all in an off state.

Next, at the beginning of anode reset phase 301, control signal SCAN3(n) may change from a low voltage value to a high voltage value, causing transistor T3 to turn on. As transistor T3 is turned on, and with transistor T5 remaining in an on state, the anode of the OLED is connected to data input voltage line VDAT. If the VDAT supply is set to a suitable low voltage relative to second power supply voltage ELVSS, any light emission from the OLED may be avoided. In some embodiments, data input voltage line VDAT may be held to such a low voltage throughout the operation of all pixel rows during non-refresh mode, as data input voltage line VDAT is not employed to provide new data to the pixel row at that time. At an end of anode reset phase 301, control signal SCAN3(n) may then change from a high voltage value to a low voltage value once the OLED has been reset, thus disconnecting data input voltage line VDAT from the anode of the OLED.

Also at the end of anode reset phase 301, in some embodiments, emission control signal EMI(n) is changed from a high voltage value to a low voltage value, causing transistors T1 and T5 to turn off. Accordingly, with transistor T1 in an off state, no current flows through drive transistor TD, as first power supply voltage ELVDD is no longer connected to the drain terminal of drive transistor TD. Further, with transistor T5 in an off state, the lower plate of storage capacitor C₀ at first node N1 is disconnected from the source terminal of drive transistor TD at this point, leaving the source terminal of drive transistor TD floating.

Thereafter, at the beginning of on-bias stress phase 302 (e.g., defined as a 1H time period after the end of anode reset phase 301 in FIG. 3), control signal SCAN2(n) is changed from a low voltage value to a high voltage value, causing transistor T4 to turn on. As transistor T4 is turned on, initialization voltage input line VINI is applied to the source terminal of drive transistor TD. In some embodiments, initialization voltage input line VINI, as employed during low-frequency mode 300, may or may not be the same as initialization voltage input line VINI during normal mode 200.

The voltage difference between the gate and source terminals of drive transistor TD will then be the pre-programmed gate voltage minus the initialization voltage input line VINI voltage applied at the source terminal of drive transistor TD, as follows:

(V_{INI,R}+V_{TH}−(V_{DAT,R}+ΔV_{A})+(V_{DAT,NR}−V_{oled}))−V_{INI,NR}

In the above expression, V_{INI,R} and V_{DAT,R} are the voltage levels of initialization voltage input line VINI and data voltage input line VDAT, respectively, from normal mode 200 (e.g., the refresh frame), and V_{INI,NR} and V_{DAT,NR} are the voltage levels of initialization voltage input line VINI and data voltage input line VDAT, respectively, from low-frequency mode 300 (e.g., the non-refresh frame). The magnitude of the voltage difference is primarily determined by the V_{INI,NR} voltage level. A relatively high voltage stress between the gate and source terminals of drive transistor TD may reduce the hysteresis of threshold voltage V_{TH} of the TFT drive transistor TD. The hysteresis refers to the dependence of threshold voltage V_{TH} on the previously applied gate-source voltage stress.

At an end of on-bias stress phase 302, control signal SCAN2(n) is changed from a high voltage value to a low voltage value, causing transistor T4 to turn off. As transistor T4 is turned off, initialization voltage input line VIM is disconnected from the source terminal of drive transistor TD. As depicted in FIG. 3, the length of the pulse of control signal SCAN2(n) pulse in on-bias stress phase 302 is 3H, but the length of this pulse may be increased or decreased to alter the amount of stress applied to drive transistor TD.

After on-bias stress phase 302, circuit configuration 100 is then operable in emission phase 204, during which the OLED is capable of emitting light. At the beginning of emission phase 204, control signal EMI(n) is changed from a low voltage value to a high voltage value, causing transistors T1 and T5 to turn on. When on, transistor T5 connects the lower plate of storage capacitor C₀ to the source terminal of drive transistor TD, using the charge on storage capacitor C₀ to apply the desired gate-source voltage to drive transistor TD, and to the OLED anode, ensuring that as V_{OLED} changes, the gate-source voltage of drive transistor TD is consistent. As the gate-source voltage of drive transistor TD is maintained by the same charge as that provided during normal mode 200, the associated current flows to the OLED during low-frequency mode 300 may be similar to those provided during normal mode 200, as shown below:

$${I}_{OLED} = \frac{β}{2} {( {V}_{INI} - {V}_{DAT} - Δ {V}_{A} )}^{2}$$

During low-frequency mode 300, only control signals EMI(n), SCAN2(n), and SCAN3(n) are operating (i.e., changing state). Consequently, the gate voltage of drive transistor TD and the charge on storage capacitor C₀ are kept the same during low-frequency mode 300 as generated during the most recent normal mode 200 while overall power consumption is reduced.

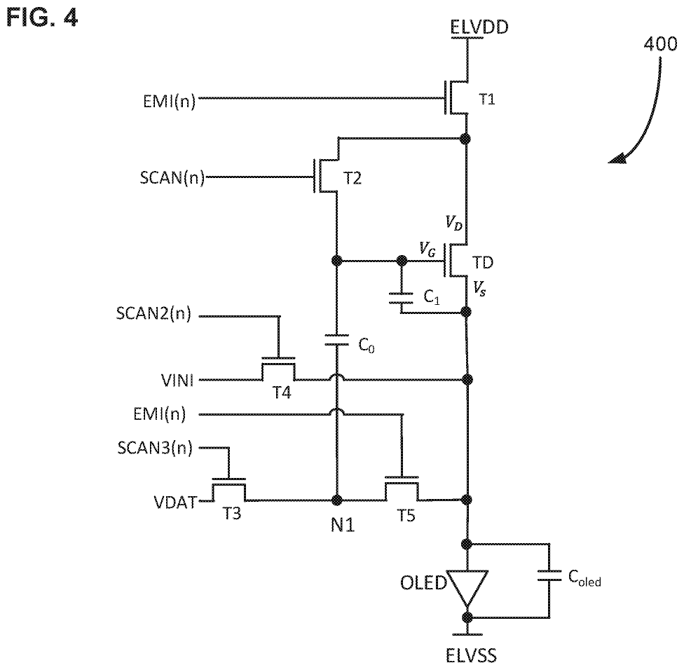

FIG. 4 is a drawing depicting a circuit configuration 400 in accordance with embodiments of the present disclosure. In some embodiments, the timing and operational methods of circuit configuration 400 may be substantially the same as those of circuit configuration 100. Circuit configuration 400 may also operate in both normal mode 200 (e.g., a refresh frame) and low-frequency mode 300 (e.g., non-refresh frame), as described above, as the timing diagrams of FIGS. 2 and 3 are suitable for use with circuit configuration 400. Circuit configuration 400, however, differs from circuit configuration 100 in that a second storage capacitor C₁ is connected between the gate and source terminals of drive transistor TD in circuit configuration 400. Compared to circuit configuration 100, circuit configuration 400 benefits from adding second storage capacitor C₁ by allowing electrical charge from data voltage input line VDAT to be divided between storage capacitors C₀ and C₁, depending on their relative capacitance values. This change may be advantageous, for example, if drive transistor TD possesses a steep drain-current-vs.-gate-source-voltage response (e.g., a small change in the gate-source voltage produces a significantly larger drain current change). The relative sizes of storage capacitors C₀ and C₁ may then determine the magnitude of the gate-source voltage applied to drive transistor TD.

Initialization phase 201, combined threshold compensation and data programming phase 202, and continued threshold compensation phase 203 may occur the same way as in circuit configuration 100, as depicted in FIG. 2, but with the use of the additional storage capacitor C₁ connected across the gate and source terminals of drive transistor TD. During emission phase 204, the upper plates of storage capacitors C₀ and C₁ are connected to each other and to the gate terminal of drive transistor TD, and the lower plates of capacitors C₀ and C₁ are electrically connected to each other and to the anode of the OLED and the source terminal of drive transistor TD when transistor T5 is put into an on state at the start of emission phase 204. The charge on each storage capacitor C₀ and C₁ is shared therebetween, thus setting the voltage between the gate and source terminals of drive transistor TD.

At the end of continued compensation phase 203, the voltage across first storage capacitor C₀ will be the same as in circuit configuration 100, as indicated in the equation below:

V_{C0}=V_{INI}+V_{TH}−(V_{DAT}+ΔV_{A})

At the same time, the voltage across second storage capacitor C₁ may be equal to threshold voltage V_{TH} of drive transistor TD:

V_{C1}=V_{TH}

Assuming the voltage at the anode of the OLED is V_{OLED}, and the gate terminal of drive transistor TD (e.g., to which the upper plates of storage capacitors C₀ and C₁ are connected) is floating, then the total voltage at the upper plates (and therefore at the gate terminal of drive transistor TD) may be calculated as follows:

$$\frac{( {V}_{OLED} + {V}_{C 0} ) {C}_{0} + ( {V}_{OLED} + {V}_{C 1} ) {C}_{1}}{{C}_{0} + {C}_{1}} = \frac{( {V}_{OLED} + {V}_{INI} + {V}_{TH} - ( {V}_{DAT} + Δ {V}_{A} ) ) {C}_{0} + ( {V}_{OLED} + {V}_{TH} ) {C}_{1}}{{C}_{0} + {C}_{1}} = {V}_{OLED} + {V}_{TH} + ( {V}_{INI} - {V}_{DAT} - Δ {V}_{A} ) \frac{{C}_{0}}{{C}_{0} + {C}_{1}}$$

Comparing this equation with the corresponding equation provided above in connection with circuit configuration 100, the voltages at the gate terminal of drive transistor TD are substantially the same, except that the terms V_{INI}, V_{DAT}, and ΔV_{A} are scaled by the factor C₀/(C₀+C₁). Therefore, the relative sizes of storage capacitors C₀ and C₁ may be chosen to alter the amount that the data voltage V_{DAT} of voltage data input line VDAT is scaled down when presented at the gate terminal of drive transistor TD.

Given this voltage, the current that flows through the OLED may be as follows:

$${I}_{OLED} = \frac{β}{2} {( {V}_{TH} + \frac{( {V}_{INI} - {V}_{DAT} - Δ {V}_{A} ) {C}_{0}}{{C}_{0} + {C}_{1}} - {V}_{TH} )}^{2} = \frac{β}{2} {( ( {V}_{INI} - {V}_{DAT} - Δ {V}_{A} ) \frac{{C}_{0}}{{C}_{0} + {C}_{1}} )}^{2}$$

In the above equation,

$$β = {μ}_{n} \cdot {C}_{ox} \cdot \frac{W}{L}$$

is the current gain (beta) of drive transistor TD, Cₒₓ is the capacitance of the gate oxide of drive transistor TD, W is the width of the channel of drive transistor TD, L is the length of the channel of drive transistor TD (i.e., the distance between the source and drain terminals), and μₙ is the carrier mobility of drive transistor TD.

Accordingly, the current to the OLED in circuit configuration 400, as was shown above with respect to circuit configuration 100, does not depend on either threshold voltage V_{TH} of drive transistor TD or any voltage variations of the OLED, as circuit configurations 100 and 400 compensate for such variations.

During emission phase 204, storage capacitors C₀ and C₁ are connected in parallel. Accordingly, the voltage across both storage capacitors C₀ and C₁ is utilized for driving the OLED during emission phase 204. In some embodiments, a certain (e.g., minimum) capacitance may be necessary to maintain stability of the gate voltage of drive transistor TD during emission phase 204 to achieve stable light emission. With storage capacitors C₀ and C₁ connected commonly at the upper and lower plates during emission phase 204, smaller capacitors are usable compared to conventional configurations that employ a single storage capacitor C₀ to achieve comparable performance and stability of the light emission. Such use of smaller capacitors may be advantageous in high-resolution displays in which spatial limitations are significant.

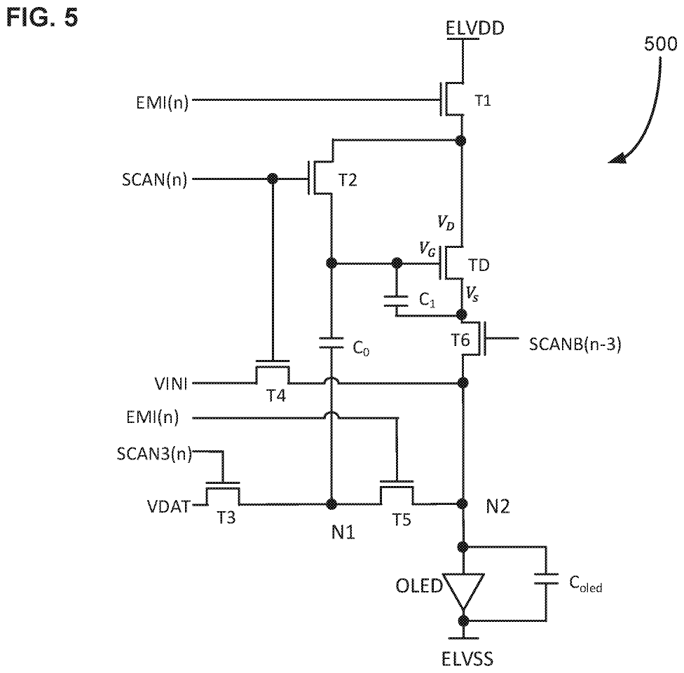

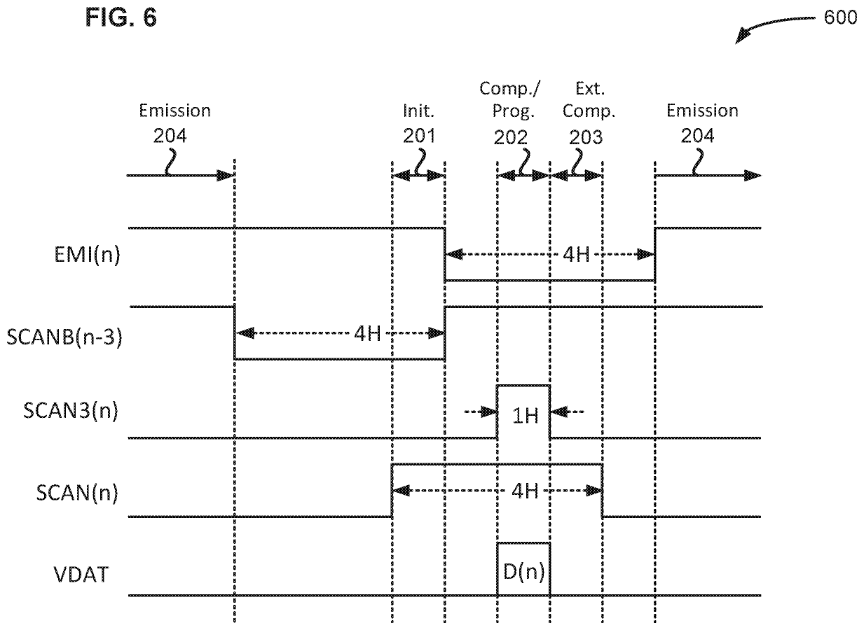

FIG. 5 is a drawing depicting a circuit configuration 500 in accordance with embodiments of the present disclosure, and FIG. 6 is a timing diagram associated with a normal mode 600 of operation of circuit configuration 500 of FIG. 5. Circuit configuration 500 of FIG. 5 operates comparably to circuit configurations 100 and 400 in normal mode 600, except that circuit configuration 500 includes an additional switching transistor T6 between the source terminal of drive transistor TD and a second node N2, which interconnects a terminal of transistor T4, a terminal of transistor T5, and the anode of the OLED. Transistor T6, as employed in FIG. 5, may only affect the operation of initialization phase 201 of FIG. 6. Inclusion of transistor T6 may be effective with either of one storage capacitor C₀ (FIG. 1) or two storage capacitors C₀ and C₁. (FIG. 4). Circuit configuration 500 of FIG. 5 is illustrated with two storage capacitors C₀ and C₁.

During emission phase 204 of FIG. 6, control signal SCANB(n−3), which controls the gate terminal of transistor T6, is held at a high voltage value, thus keeping transistor T6 in an on state. Accordingly, due to transistor T5 also being in the on state at this time, storage capacitor C₀ is connected between the gate and source terminals of drive transistor TD during at least emission phase 204. At the end of emission phase 204, control signal SCANB(n−3) changes from a high voltage value to a low voltage value, thus placing transistor T6 into an off state. This action disconnects the lower plate of capacitor C₀ and first node N1 from the source terminal of drive transistor TD, such that the appropriate driving gate-source voltage is no longer present at drive transistor TD. At this point, transistor T6 also disconnects the source terminal of drive transistor TD from second node N2 and the anode of the OLED, thus preventing current from flowing into the OLED from first power supply voltage ELVDD, resulting in cessation of light emission from the OLED. This operation may occur before initialization phase 201 begins, as depicted in the timing diagram of FIG. 6, or may occur at the start of initialization phase 201 itself In the former case, a longer period of time without light emission may result in comparison to the latter case, but the programming operation of circuit configuration 500 may otherwise be the same.

At the start of initialization phase 201, control signal SCAN(n) changes from a low voltage level to a high voltage level, thus turning both the diode-connecting transistor T2 and transistor T4 from the off state to the on state. As a result, transistor T2 connects the drain and gate terminals of drive transistor TD together. Also during initialization phase 201, both the drain and gate terminals of drive transistor TD are connected to first power supply voltage ELVDD through transistor T1 (which is also in the on state at that time), which initializes the gate and drain terminals to a high voltage level. Transistor T4 connects initialization voltage input line VINI to the anode of the OLED and to first node N1 (by way of transistor T5), which is connected to the lower plate of storage capacitor C₀. Initializing the lower plate of storage capacitor C₀ to initialization voltage input line VINI has the benefit of setting the charge on capacitor C₀ to an identical potential on each refresh frame of normal mode 600, which removes the previously programmed data value from the pixel entirely, thus removing the effect of the previously programmed data voltage on the current refresh frame.

Because transistor T6 is in an off state during initialization phase 201, current cannot flow from first power supply voltage ELVDD to initialization voltage input line VINI. If, instead, transistor T6 was either in an on state or not implemented in the circuit configuration 500, current may flow from first power supply voltage ELVDD to initialization voltage input line VINI, possibly causing significant power consumption for the entire initialization phase 201. In some embodiments, the voltages initialized to the gate and drain terminals of drive transistor TD and the first node N1 may also be inaccurate because high current passing through the on-resistance of the turned-on transistors T1, T2, T4, and T5 may introduce a significant voltage drop. This scenario may result in lower initialization voltages being programmed to these nodes, as well as variation of the levels of emitted light among different pixels due to different initialization of pixels. This varying initialization, in turn, may be due to transistor property variation and/or voltage drops on supply lines because of the high current and resistance of the lines, known as “IR drop.” Such variations may thus lead to poor image quality across the entire pixel array. Additionally, the timing diagram employed in FIG. 6 for normal mode 600 also facilitates the use of a common control signal, SCAN(n), to control transistors T2 and T4, which were previously controlled using separate control signals in circuit configurations 100 and 400 to avoid the high-power consumption state described above. The use of transistor T6 thus reduces the number of control lines required to operate circuit configuration 500, which may lead to a smaller pixel size that may be advantageous in high-resolution displays.

At the end of initialization phase 201 of FIG. 6, control signal SCANB(n−3) switches from a low voltage level to a high voltage level, changing the state of transistor T6 to an on state. Substantially simultaneously, emission control signal EMI(n) changes from a high voltage level to a low voltage level, which switches the state of transistors T1 and T5 to an off state. Turning transistor T6 on connects the source of drive transistor TD to second node N2, resulting in initialization voltage line input VINI being connected to drive transistor TD. This connection produces a high drain-source voltage across drive transistor TD after the drain terminal was previously initialized to first power supply voltage ELVDD via transistor T1 during initialization phase 201. Turning transistor T5 off disconnects first node N1 from second node N2, thus leaving first node N1 and the lower plate of storage capacitor C₀ floating rather than being driven to initialization voltage input line VINI, as occurred via transistor T4 during initialization phase 201. Turning transistor T1 off disconnects the diode-connected drain and gate terminals of drive transistor TD from first power supply voltage ELVDD. This disconnection by transistor T1, when combined with the connection of the source terminal of drive transistor TD to initialization voltage input line VINI via transistor T6, may lead to the threshold compensation action beginning with the gate and drain terminals of drive transistor TD falling towards the voltage potential of initialization voltage input line VINI, as described in the above embodiments.

The start of combined threshold compensation and data programming phase 202 may occur at the same time as the end of initialization phase 201, as described above. However, the timing diagram of FIG. 6 depicts a delay between the end of initialization phase 201 and the start of combined threshold compensation and data programming phase 202. Such a delay may be useful if the falling edge of control signal EMI(n) and the rising edge of control signal SCANB(n−3) are slower than the rising edge of control signal SCAN3(n). Without such a delay under these circumstances, applying data voltage line input VDAT to first node N1 (e.g., before first node N1 is disconnected from second node N2 by the opening of transistor T5) may adversely affect the initialization of second node N2, thus possibly causing significant errors to the subsequent phases. If a delay is included between the end of initialization phase 201 and the start of combined threshold compensation and data programming phase 202, then the threshold compensation action may begin before data voltage input line VDAT is applied to first node N1 via transistor T3. Accordingly, the diode-connected gate and drain terminals of drive transistor TD may have already begun to approach the voltage potential of initialization voltage line input VINI. In some embodiments, this delay may not significantly affect the accuracy of the threshold compensation, as the compensation may continue for the entirety of combined threshold compensation and data programming phase 202 and continued threshold compensation phase 203 after the application of data voltage input line VDAT to first node N1 disturbs the voltage at the gate and drain terminals of drive transistor TD. The most significant impact of the delay may be that if data voltage input line VDAT is significantly lower than initialization voltage input line VINI, then applying data voltage input line VDAT to first node N1 may pull the voltage at the gate and drain terminals of drive transistor TD below the voltage level of V_{INI}+V_{TH}. This voltage drop may cause threshold voltage V_{TH} of drive transistor TD to be compensated incorrectly, as the gate-source voltage V_{GS} may be less than threshold voltage V_{TH}. A resulting impact of this improper compensation may be reduced accuracy at high output currents, as the more negative data voltage input line VDAT is, the higher the output current of drive transistor TD may be.

In some embodiments, combined threshold compensation and data programming phase 202 and all subsequent phases may function in the same way as in circuit configurations 100 and 400, and thus will not be described in greater detail.

Because circuit configuration 500 of FIG. 5 uses a common control signal SCAN(n) to control both transistors T2 and T4, an on-bias stress phase for a low-frequency mode may not be implemented, unlike circuit configurations 100 and 400. To apply initialization voltage line input VINI to the source terminal of drive transistor TD by turning transistor T4 on may also result in connecting the gate and drain terminals of drive transistor TD through transistor T2. This operation may lead to current flowing through drive transistor TD from storage capacitors C₀ and C₁, thus altering the charge stored at the gate terminal of drive transistor TD and corrupting the programmed state of the pixel from the foregoing normal mode 600 operation. As a result, circuit configuration 500 of FIG. 5 may not be operated in a low-frequency mode. If, instead, the control signals for transistors T2 and T4 were separated, then an on-bias stress phase could be implemented in the manner similar to that of low-frequency mode 300 of FIG. 3, as described above for circuit configurations 100 and 400. To implement a low-frequency mode for circuit configuration 500, an increased number of control signal lines may be routed into the pixel, which may increase the size of the pixel, which may be undesirable for high-resolution applications. Also, such an implementation may also increase the number of drivers needed to generate the additional control signals, which may be detrimental if a small bezel for the display device is desired.

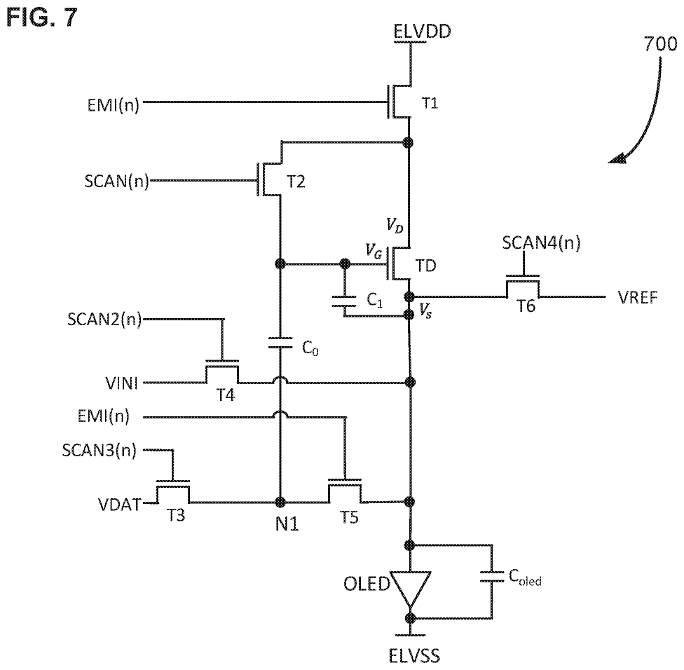

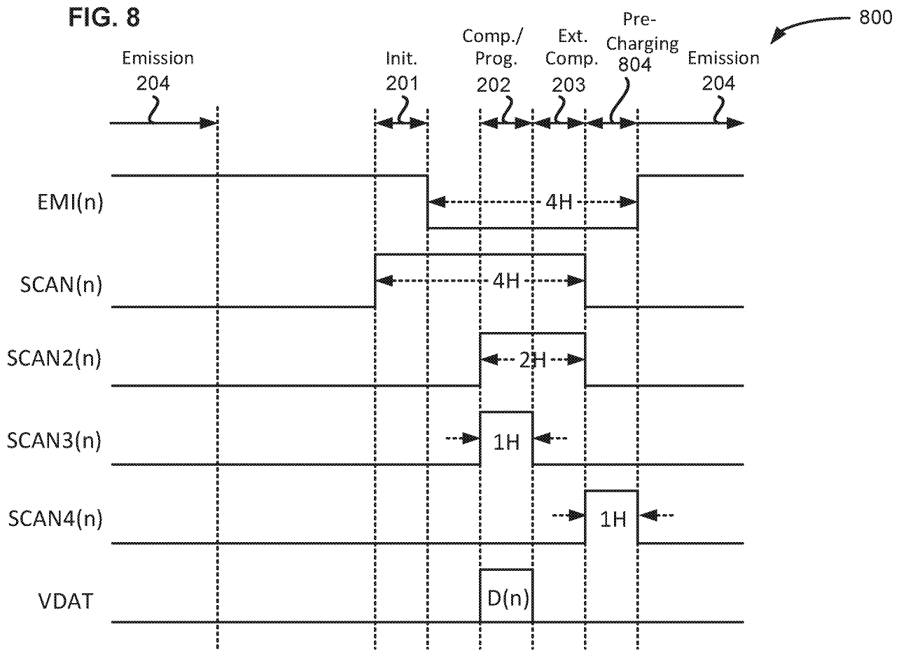

FIG. 7 is a drawing depicting a circuit configuration 700 in accordance with embodiments of the present disclosure. FIG. 8 is a timing diagram associated with a normal mode 800 operation of circuit configuration 700 of FIG. 7. Circuit configuration 700 may also employ low-frequency mode 300 of FIG. 3, as described above. Circuit configuration 700 of FIG. 7 may operate comparably to circuit configurations 100, 400, and 500, except for an additional switching transistor T6 having a first terminal connected to the source terminal of drive transistor TD and a second terminal connected to a reference voltage input line VREF. Transistor T6 introduces a new pre-emission phase 804, as illustrated in FIG. 8, and does not affect any of the previous phases 201-203, as those phases are described above. Inclusion of transistor T6 and usage of this transistor in the manner described below may also be effective with any of circuit configurations 100, 400, and 500. As described, circuit configuration 700 of FIG. 7 is substantially embodied as circuit configuration 400 of FIG. 4 with transistor T6 incorporated therein.

During initialization phase 201, combined threshold compensation and data programming phase 202, and continued threshold compensation phase 203, transistor T6 is in an off state and does not affect the operation of circuit configuration 700. By the completion of continued threshold compensation phase 203, threshold voltage V_{TH} of drive transistor TD and the voltage of data voltage input line VDAT will have been written to circuit configuration 700 and stored on storage capacitors C₀ and C₁ between the gate and source terminals of drive transistor TD, as described in the above embodiments.

At the start of an anode pre-charging phase 804, control signal SCAN4(n) switches from a low voltage level to a high voltage level, putting transistor T6 into an on state. Transistor T6 thus connects reference voltage input line VREF to the source terminal of drive transistor TD, the anode of the OLED, and the lower plate of storage capacitor C₁, resulting in this node being shifted from the voltage of initialization voltage input line VINI to the voltage of reference voltage input line VREF. Because the lower plate of storage capacitor C₁ is connected to this new voltage, it may drive up the voltage at the gate terminal by the amount of the voltage of reference voltage input line VREF minus the voltage of initialization voltage input line VINI (V_{REF}−V_{INI}) such that the voltage across the gate and source terminals is substantially identical to the voltage stored there prior to anode pre-charging phase 804 (e.g., ignoring the effect of any parasitic capacitances on these nodes). As the lower plate of storage capacitor C₀ remains floating, the voltage stored there will shift upward by the same amount, with the same charge being stored on storage capacitor C₀.

A significant result of anode pre-charging phase 804 is that parasitic OLED capacitance C_{oled} is charged to sustain this higher voltage at the anode of the OLED. Without anode pre-charging phase 804, at the start of emission phase 204, the voltage at the OLED anode is the voltage of initialization voltage input line VINI, which is normally set to less than the OLED threshold voltage above second power supply voltage ELVSS to avoid light emission from the OLED during the programming of the pixel. However, in emission phase 204, the anode should proceed to a higher potential above the OLED threshold voltage, and enough charge may need to be stored in parasitic capacitance C_{oled} to retain this voltage. In some embodiments, a uniform amount of charge may be stored in parasitic capacitance C_{oled} regardless of the programmed data voltage because, in substantially every case, parasitic capacitance C_{oled} may be charged to the same voltage potential (e.g., at reference voltage input line VREF) before emission phase 204.

Without anode pre-charging phase 804, when the pixel is programmed to emit a high optical output, drive transistor TD may provide a large current to the OLED, and only a relatively short time may be required to charge parasitic capacitance C_{oled} to the required level. If a small voltage error is present in the programmed value, the effect on the speed of charging the OLED may be quite small, and the difference in the optical output, averaged over a frame, may be related only to the final, fully charged output level. However, when the pixel is programmed to emit a low optical output, drive transistor TD only provides a very small current to the OLED and thus may require a significant amount of time to charge parasitic capacitance C_{oled}. Consequently, the optical output from the OLED may slowly ramp up to the final output level. If a small voltage error is present in the programmed value, the effect on the speed of charging the OLED may be significant, particularly if drive transistor TD is operating in the sub-threshold region, where changes in the gate voltage result in an exponentially larger change in the drain current. The difference in the optical output averaged over a frame may be heavily dependent on the speed of the charging and may be many times greater than the difference in the final output level.

By including anode pre-charging phase 804 and setting reference voltage input line VREF to roughly equal the OLED threshold voltage, if a low optical output has been programmed, the error from charging parasitic capacitance C_{oled} that was described above may not be present, as parasitic capacitance C_{oled} may already be charged to a very similar potential. This pre-charging may reduce errors in the optical output when averaged over the whole frame.

As illustrated in FIG. 8, in at least some embodiments, anode pre-charging phase 804 is conducted just before emission phase 204 begins so that the larger voltage potential across the OLED that is present after anode pre-charging phase 804 (e.g., the voltage of reference voltage input line VREF minus second power supply voltage ELVSS (V_{REF}−V_{ELVSS})) may be present just before emission phase 204 begins. This timing reduces both the length of time the OLED is stressed by this higher voltage potential and the duration of any light emission from the OLED that may result from this voltage potential.

At the end of anode pre-charging phase 804, control signal SCAN4(n) changes from a high voltage level to a low voltage level, thus turning off transistor T6. Accordingly, the source terminal of drive transistor TD is disconnected from reference voltage input line VREF, and the voltages stored at each node are retained. Emission phase 204 may then follow the same procedure as outlined in the previous circuit configurations discussed above.

As indicated above, circuit configuration 700 employs an additional scan signal, control signal SCAN4(n), to control transistor T6. However, if fewer control signals are needed to reduce the size of the drivers and, therefore, the bezel of the display device, a delayed version of another signal, such as SCAN3(n+2) or SCAN2(n+2), may also be used for this purpose. In such cases, the functionality of the operations will be substantially the same as described above.

To implement a low-frequency mode in circuit configuration 700, control signals EMI(n), SCAN2(n), and SCAN3(n) may be controlled as depicted in low-frequency mode 300 of FIG. 3 for circuit configuration 100 of FIG. 1, with transistor T6 being maintained in the off state during low-frequency mode 300.

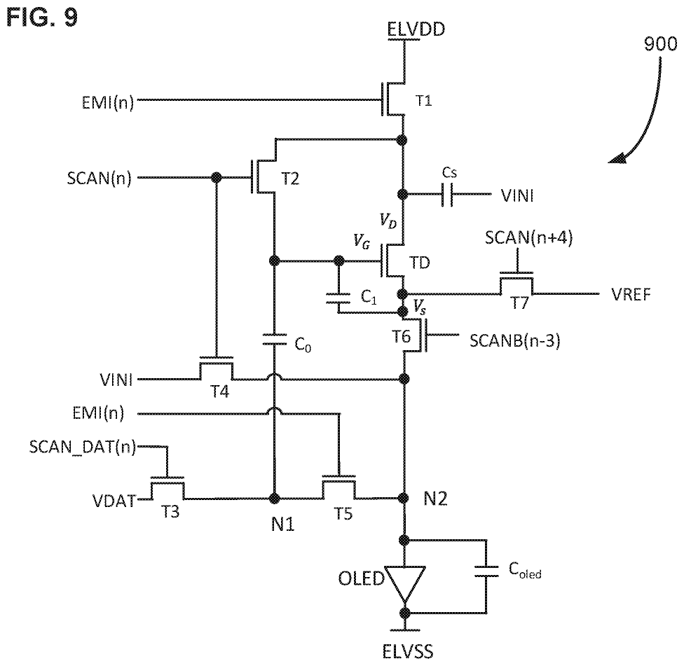

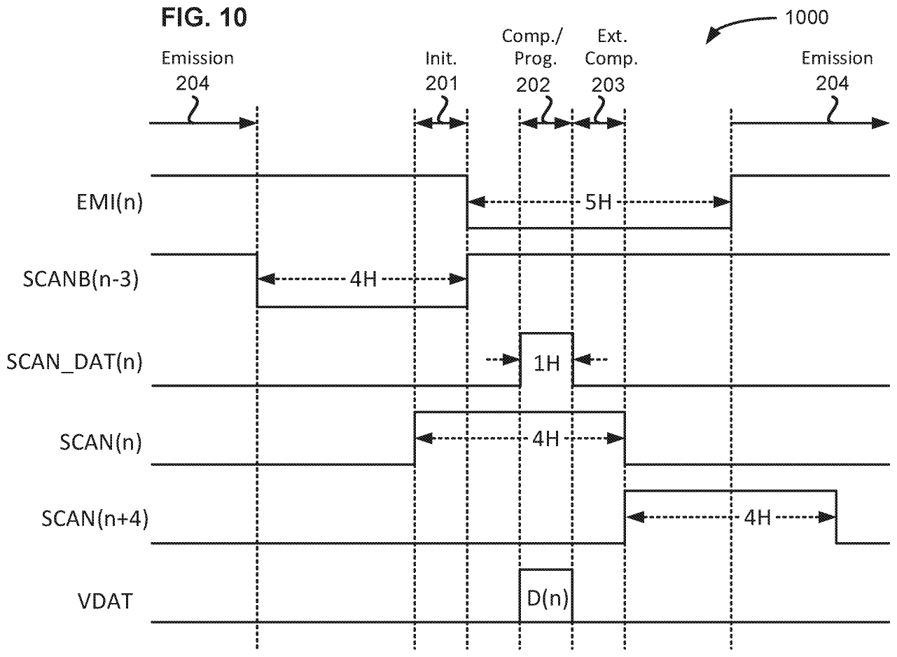

FIG. 9 is a drawing depicting a circuit configuration 900 in accordance with embodiments of the present disclosure, and FIG. 10 is a timing diagram associated with a normal mode 1000 operation of circuit configuration 900 of FIG. 9. Circuit configuration 900 may operate comparably to circuit configurations 500 and 700, with the exception of a stabilizing capacitor Cₛ positioned between the drain terminal of drive transistor TD and initialization voltage input line VINI. In some embodiments, stabilization capacitor Cₛ may only significantly affect the operation of configuration circuit 900 between the end of extended compensation phase 203 and the start of emission phase 204, as depicted in FIG. 10. The size of stabilization capacitor Cₛ may be appropriately small (e.g., 10 femtofarads (fF) or less) such that stabilization capacitor Cₛ has little impact on the overall capacitance at the gate terminal of drive transistor TD during combined threshold compensation and data programming phase 202 or continued threshold compensation phase 203. Inclusion of storage capacitor Cₛ may also be effective in any combination of previous circuit configurations 100, 400, 500, and 700. As shown in FIG. 9, circuit configuration 900 may include both initialization transistor T6 between the source terminal of drive transistor TD and second node N2 (e.g., as depicted in circuit configuration 500 of FIG. 5) and a pre-charging transistor T7 between the source terminal of the drive transistor TD and reference voltage input line VREF (e.g., illustrated as transistor T6 in circuit configuration 700 of FIG. 7).

In some embodiments, stabilization capacitor Cₛ is included in circuit configuration 900 to reduce the amount that the voltage at the gate terminal of drive transistor TD may change between the end of continued threshold compensation phase 203 and the start of emission phase 204, as depicted in FIG. 10. At the end of continued threshold compensation phase 203, control signal SCAN(n), connected to the gate terminals of transistors T2 and T4, changes from a high voltage level to a low voltage level. As a result, transistor T2 disconnects the drain and gate terminals of drive transistor TD from each other. Further, transistor T4 disconnects the source terminal of drive transistor TD and second node N2 from initialization voltage input line VINI, as transistor T6 remains in an on state at this point. This operation may lead to the voltages of the drain and gate terminals of drive transistor TD being reduced, as charge drains from these nodes to initialization voltage input line VINI while transistors T2 and T4 open. The larger this voltage change at the drain and gate terminals of drive transistor TD, the more error that is introduced into the compensated voltage for drive transistor TD. This error may occur because parasitic capacitances present at the gate terminal of drive transistor TD will change as transistors T2 and T4 change state (e.g., turn off), and consequently, the amount of charge stored on storage capacitors C₀ and C₁ may be distributed among a different set of storage elements after this event. A large voltage reduction before transistors T2 and T4 fully open may therefore indicate that a similarly large voltage increase may be needed when emission phase 204 begins, at which point the voltages of the source and gate terminals of drive transistor TD increase as the OLED anode voltage increases when the OLED begins to draw current and emit light. Under these circumstances, proportionally more error may be introduced into the final gate voltage depending on the size of the voltage change. Even slight changes to the programmed gate-source voltage of drive transistor TD may cause large differences in output current when drive transistor TD has a steep sub-threshold slope, such as in an IGZO transistor.

Stabilization capacitor Cₛ couples the drain terminal of drive transistor TD to a constant supply voltage (e.g., initialization voltage input line VINI) during this discharge process, thus stabilizing this lightly loaded node during the discharge event. A capacitive divider is substantially formed by the capacitance of the gate terminal of drive transistor TD and stabilization capacitor Cₛ. Given a first plate of stabilization capacitor Cₛ having a constant voltage (e.g., initialization voltage input line VINI), the voltage change at the opposing plate of stabilization capacitor Cₛ coupled to the drive terminal TD may be restricted. As a result, the voltage across the drain and gate terminals of drive transistor TD may change less with stabilization capacitor Cₛ at this node, and consequently, less error is introduced to the charge stored on storage capacitors C₀ and C₁ than without stabilization capacitor Cₛ. Hence, stabilization capacitor Cₛ may be included in embodiments of this circuit to improve the accuracy of the threshold compensation operation. The larger the value of stabilization capacitor Cₛ, the greater the stabilization effect, and the more improved the threshold compensation accuracy. However, at some point, the improvement of the threshold compensation accuracy given by a larger stabilization capacitor Cₛ may be less beneficial than the reduced size of the pixel circuitry possible by incorporating a smaller stabilization capacitor Cₛ, which may be a significant consideration for high-resolution displays.

Similar to circuit configuration 500 of FIG. 5, a common control signal (e.g., control signal SCAN(n)) for transistors T2 and T4 of circuit configuration 900 may prevent the use of a low-frequency mode, such as that employed using circuit configurations 100, 400, and 700. As discussed above, separate control signals for transistors T2 and T4 may allow the use of a low-frequency mode with the trade-off of an increased number of control signals.

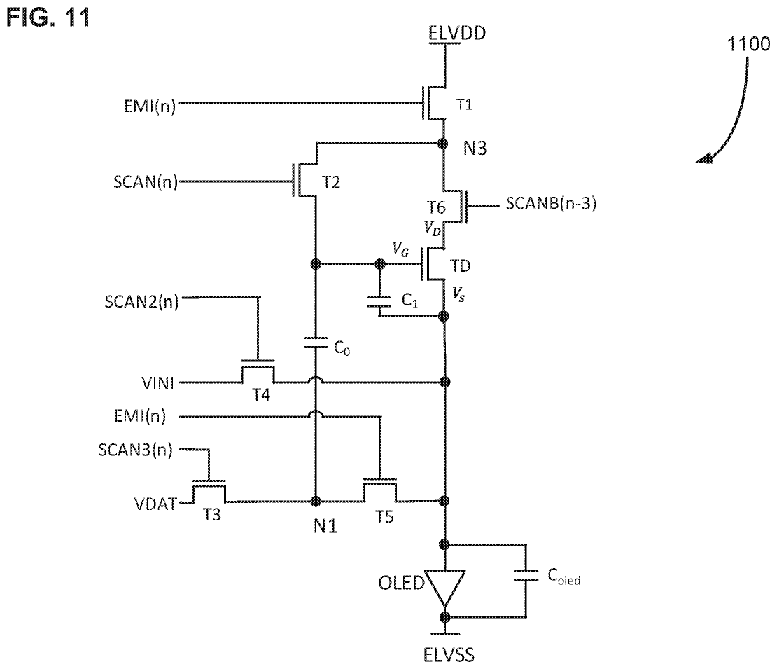

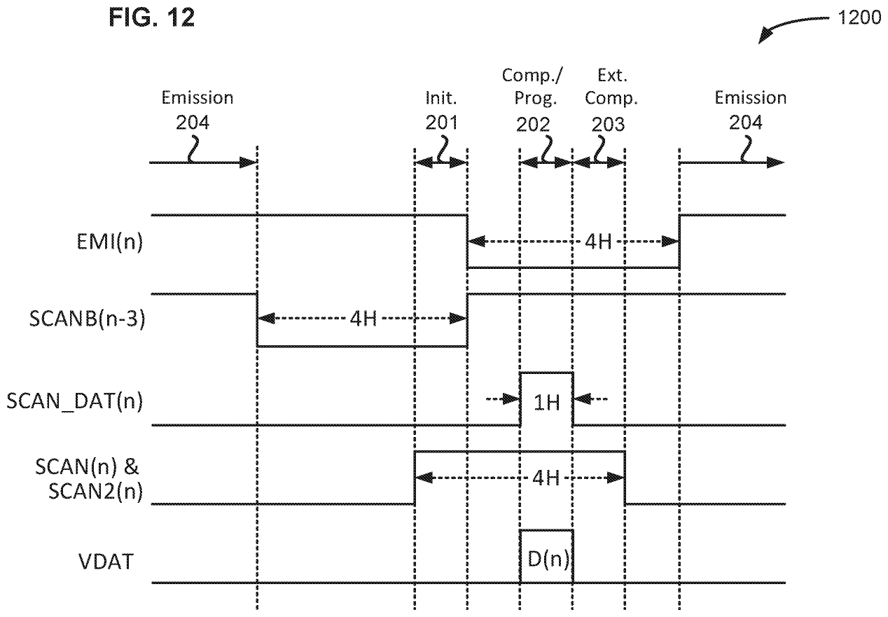

FIG. 11 is a drawing depicting a circuit configuration 1100 in accordance with embodiments of the present disclosure, and FIG. 12 is a timing diagram of a normal mode 1200 associated with the operation of circuit configuration 1100 of FIG. 11. Unlike circuit configurations 500 and 900, circuit configuration 1100 may be operated in low-frequency mode 300 of FIG. 3. Circuit configuration 1100 of FIG. 11 operates similarly to circuit configuration 500 of FIG. 5, with an improved initialization phase 201, except for the circuit position of additional switching transistor T6 between the drain terminal of drive transistor TD and a third node N3 that connects one terminal of diode-connecting transistor T2 and a terminal of switching transistor T1. (In contrast, in circuit configuration 500, switching transistor T6 is located at the source terminal of drive transistor TD, as shown in FIG. 5.) In circuit configuration 1100, transistor T6 is turned off before, or at the start of, initialization phase 201 (as shown in FIG. 12), ensuring that first power supply voltage ELVDD is not connected to the drain terminal of drive transistor TD, thus preventing drive transistor TD from drawing current. This functionality allows initialization voltage input line VINI to be applied to node N1 through transistors T4 and T5 during initialization phase 201 without large currents being sunk from first power supply voltage ELVDD to initialization voltage VINI through drive transistor TD, which may otherwise cause the problems described above in connection with some of the above embodiments. At the end of initialization phase 201, transistor T6 is turned on, and combined programming and compensation phase 202, extended compensation phase 203, and emission phase 204 of normal mode 1200 operate substantially identically to how they do in normal mode 600 for circuit configuration 500.

While circuit configuration 1100 is depicted with two storage capacitors C₀ and C₁, a single storage capacitor C₀, as illustrated in circuit configuration 100 of FIG. 1, may be employed in other embodiments. Further, in some embodiments, circuit configuration 1100 may additionally include a stabilization capacitor Cs (e.g., connected to the drain terminal of drive transistor TD, as depicted in circuit configuration 900 of FIG. 9). Also, in some embodiments, circuit configuration 1100 may additionally incorporate a transistor to pre-charge the anode of the OLED (e.g., transistor T6 of circuit configuration 700 to electrically couple reference voltage VREF to the source terminal of drive transistor TD during a pre-charging phase 804 of FIG. 8).

As mentioned above, circuit configuration 1100 may also be operated in a low-frequency mode, such as low-frequency mode 300 of FIG. 3. In such embodiments, transistor T6 may be constantly held in an on state during low-frequency mode 300.

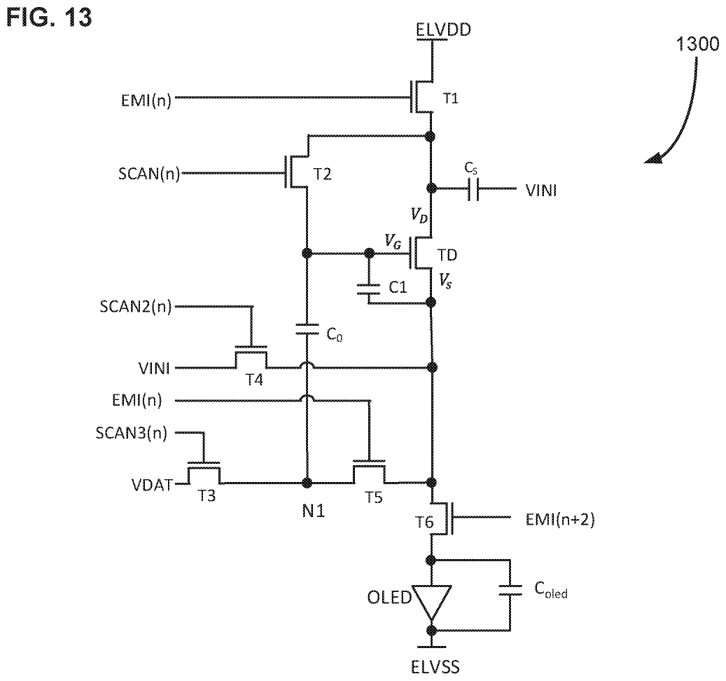

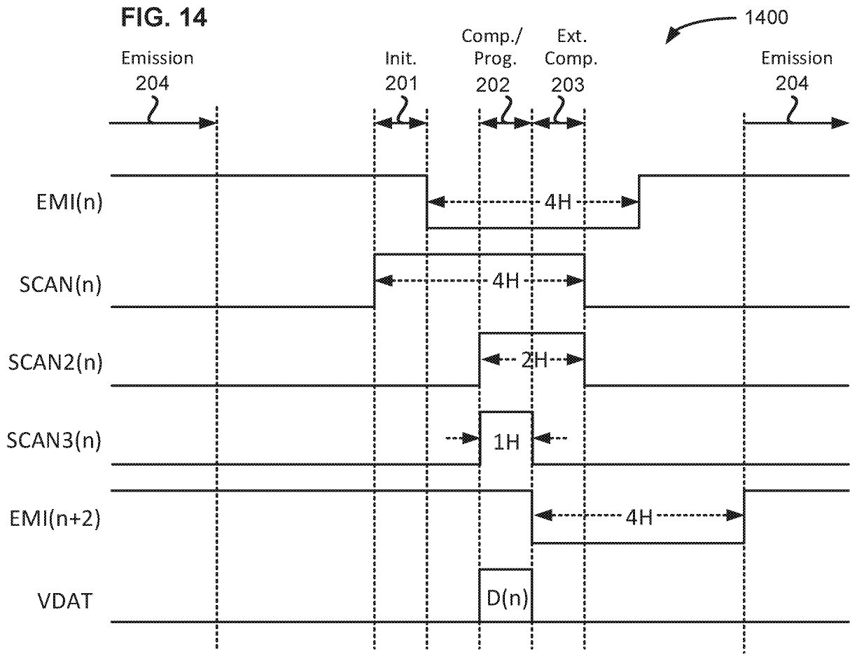

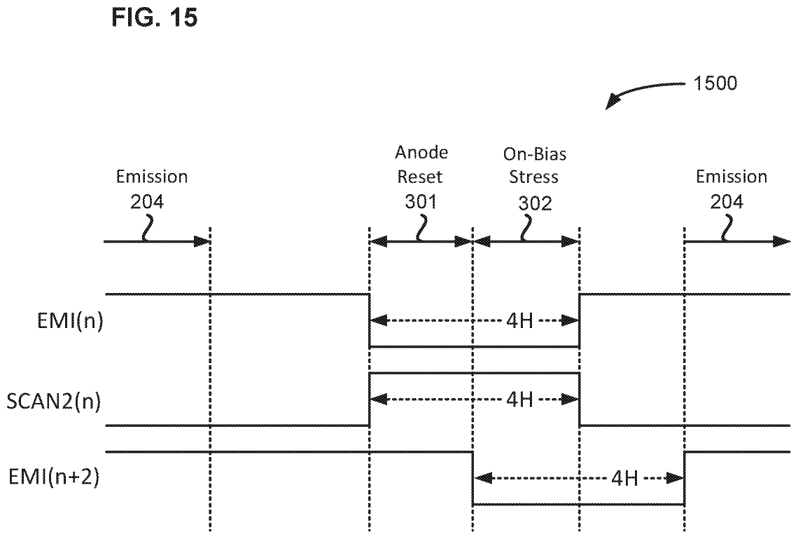

FIG. 13 is a drawing depicting a circuit configuration 1300 in accordance with embodiments of the present disclosure. In addition, FIG. 14 is a timing diagram associated a normal mode 1400 of operation for circuit configuration 1300, and FIG. 15 is a timing diagram associated with a low-frequency mode 1500 of operation for circuit configuration 1300. In some embodiments, circuit configuration 1300 operates similarly to circuit configuration 400 of FIG. 4, with the exception that low-frequency mode 1500 utilizes a single voltage supply (e.g., initialization voltage input line VINI, by way of transistor T4 under control of logic signal SCAN2(n)) to apply both anode reset phase 301 and on-bias stress phase 302. Consequently, low-frequency mode 1500 is distinguished from low-frequency mode 300, which employs two separate voltage supplies (e.g., data voltage input line VDAT for anode reset phase 301, and initialization voltage input line VINI for on-bias stress phase 302). To provide such functionality, an additional transistor T6, with one terminal connected to the anode of the OLED and a second terminal connected to the source terminal of drive transistor TD, is controlled by a delayed version of emission control signal EMI (e.g., control signal EMI(n+2)). The use of transistor T6 during both normal mode 1400 and low-frequency mode 1500 is described in greater detail below.

As illustrated in FIG. 14, during initialization phase 201 and combined programming and compensation phase 202 of normal mode 1400, control signal EMI(n+2) is at a high voltage value, resulting in transistor T6 being in the on state. Accordingly, during phases 201 and 202, the OLED anode is connected to the source of drive transistor TD, so that phases 201 and 202 are substantially similar to those operations, as employed in circuit configuration 400 (e.g., as shown in normal mode 200 of FIG. 2). At the start of continued threshold compensation phase 203, control signal EMI(n+2) switches from a high voltage level to a low voltage level, thus placing transistor T6 in the off state and disconnecting the OLED anode from the source terminal of drive transistor TD. In some embodiments, this operation does not affect the threshold compensation operation, as initialization voltage input line VINI remains connected to the source terminal of drive transistor TD through extended compensation phase 203. In some such embodiments, emission phase 204 may begin thereafter when control signal EMI(n+2) switches back to a high level to turn on transistor T6, instead of when emission control signal EMI(n) switches to a high voltage level to turn on transistor T1 (e.g., shown in FIG. 14 as occurring prior to emission phase 204), as no current may flow from drive transistor TD into the OLED until both transistors T1 and T6 are closed. However, this sequence of operations does not affect the voltages programmed to the pixel of circuit configuration 1300, as emission will just be delayed by two horizontal frame times (2 H) during normal mode 1400.

Low-frequency mode 1500, as depicted in FIG. 15, employs initialization voltage input line VINI during both anode reset phase 301 and on-bias stress phase 302. At the start of anode reset phase 301, emission control signal EMI(n) changes from a high voltage value to a low voltage value, thus placing transistors T1 and T5 in the off state. Consequently, node N1 is disconnected from the source terminal of drive transistor TD, thereby protecting the charge on storage capacitor C₀ from the influence of voltage changes at the source terminal of drive transistor TD. The drain terminal of drive transistor TD is also disconnected from first power supply voltage ELVDD. At the same time, control signal SCAN2(n) changes from a low voltage value to a high voltage value to turn on transistor T4. As a result, initialization voltage input line VINI is applied to the source terminal of drive transistor TD and the anode of the OLED. In some embodiments, the value of initialization voltage input line VINI may be set to an appropriate voltage level to reset the anode of the OLED and may be the same voltage employed during normal mode 1400.

At the start of on-bias stress phase 302, control signal EMI(n+2) changes from a high voltage level to a low voltage level to turn off transistor T6. This operation disconnects the anode of the OLED from the source terminal of drive transistor TD, allowing the voltage at the source terminal of drive transistor TD to be changed without altering the reset anode voltage. Once this operation is complete, the voltage level of initialization voltage input line VINI may be changed to a different value to provide an appropriate stress to drive transistor TD. In some embodiments, this operation may be carried out similarly to provide on-bias stress phase 302 in previous circuit configurations (e.g., circuit configurations 100, 400, and 700). The voltage value for initialization voltage input line VINI may be the same as, or different from, that used in anode reset phase 301 depending on how much drive transistor TD may be stressed to achieve the desired functionality.

At the end of on-bias stress phase 302, emission control signal EMI(n) changes from a low voltage level to a high voltage level, thus connecting first node N1 to the source terminal of drive transistor TD (via transistor T5) and connecting first power supply voltage ELVDD to the drain terminal of drive transistor TD (via transistor T1). At approximately this same time, control signal SCAN2(n) changes from a high voltage level to a low voltage level, thereby disconnecting initialization voltage input line VINI from the source terminal of drive transistor TD, thus ending on-bias stress phase 302. Emission phase 204 may begin thereafter when control signal EMI(n+2) changes from a low voltage level to a high voltage value to connect the OLED anode to the source terminal of drive transistor TD, thus allowing current to flow from first power supply voltage ELVDD into the anode of the OLED, as determined by the biasing of drive transistor TD.

Consequently, in some embodiments, based on circuit configuration 1300, a single input voltage (e.g., initialization voltage input line VINI) may be used for both anode reset phase 301 and on-bias stress phase 302 of low-frequency mode 1500. While circuit configuration 1300 of FIG. 13 is based primarily on circuit configuration 400, other basic circuit configurations described above (e.g., circuit configuration 100, 700, and 1100) may be employed to achieve a similar result.

Embodiments of the present disclosure are applicable to many display devices to permit display devices of high resolution with effective threshold voltage compensation and true black performance. Examples of such devices include televisions, mobile phones, personal digital assistants (PDAs), tablet and laptop computers, desktop monitors, digital cameras, and like devices for which a high-resolution display is desirable.

From the above discussion, it is evident that various techniques can be utilized for implementing the concepts of the present disclosure without departing from the scope of those concepts. Moreover, while the concepts have been described with specific reference to certain implementations, a person of ordinary skill in the art would recognize that changes can be made in form and detail without departing from the scope of those concepts. As such, the disclosure is to be considered in all respects as illustrative and not restrictive. It should also be understood that the present disclosure is not limited to the particular described implementations, but that many rearrangements, modifications, and substitutions are possible without departing from the scope of the present disclosure.

What is claimed is:

1. A pixel circuit for a display device, the pixel circuit comprising:
a drive transistor comprising a gate terminal, a first terminal, and a second terminal, the drive transistor configured to control an amount of current from a first power supply to a light-emitting device depending upon a voltage input applied to the gate terminal of the drive transistor,
the light-emitting device comprising a first terminal electrically connected to the second terminal of the drive transistor and a second terminal electrically connected to a second power supply;
a storage capacitor comprising a first plate connected to the gate terminal of the drive transistor and a second plate connected to a first node;
a first transistor comprising a first terminal connected to the first power supply and a second terminal connected to the first terminal of the drive transistor;
a second transistor comprising a first terminal connected to the first terminal of the drive transistor and a second terminal connected to the gate terminal of the drive transistor;
a third transistor comprising a first terminal connected to the first node and a second terminal connected to a data voltage input line;
a fourth transistor comprising a first terminal connected to the second terminal of the drive transistor and a second terminal connected to a preset voltage input line; and
a fifth transistor comprising a first terminal connected to the first node and a second terminal connected to the second terminal of the drive transistor.

2. The pixel circuit of claim 1, further comprising a second storage capacitor comprising a first plate connected to the gate terminal of the drive transistor and a second plate connected to the second terminal of the drive transistor.

3. The pixel circuit of claim 1, further comprising a sixth transistor comprising a first terminal connected to the second terminal of the drive transistor, and a second terminal connected to the first terminal of the fourth transistor, the second terminal of the fifth transistor, and the first terminal of the light-emitting device.

4. The pixel circuit of claim 1, further comprising a sixth transistor comprising a first terminal connected to the first terminal of the drive transistor, and a second terminal connected to the second terminal of the first transistor and the first terminal of the second transistor.

5. The pixel circuit of claim 1, further comprising a stabilizing capacitor comprising a first plate connected to the first terminal of the second transistor and a second plate connected to a stabilization voltage input line.

6. The pixel circuit of claim 1, further comprising a reference transistor comprises a first terminal connected to the second terminal of the drive transistor and a second terminal connected to a reference voltage input line.

7. The pixel circuit of claim 1, further comprising a separation transistor comprising a first terminal connected to the first terminal of the fourth transistor and the second terminal of the fifth transistor, and a second terminal connected to the first terminal of the light-emitting device, wherein, in an off state, the separation transistor isolates the light-emitting device from a remainder of the pixel circuit.

8. The pixel circuit of claim 1, wherein the drive transistor, the first transistor, the second transistor, the third transistor, the fourth transistor, and the fifth transistor comprise n-type transistors.

9. The pixel circuit of claim 1, wherein at least one of the drive transistor, the first transistor, the second transistor, the third transistor, the fourth transistor, or the fifth transistor comprises an indium gallium zinc oxide (IGZO) transistor.

10. The pixel circuit of claim 1, wherein the light-emitting device comprises one of an organic light-emitting diode (OLED), a micro light-emitting diode (micro LED), or a quantum dot LED (QLED).

11. A method of operating a pixel circuit for a display device in a normal mode, the method comprising:
providing a pixel circuit comprising:
a drive transistor comprising a gate terminal, a first terminal, and a second terminal, the drive transistor configured to control an amount of current from a first power supply to a light-emitting device depending upon a voltage input applied to the gate terminal of the drive transistor,
the light-emitting device comprising a first terminal electrically connected to the second terminal of the drive transistor and a second terminal electrically connected to a second power supply;
a storage capacitor comprising a first plate connected to the gate terminal of the drive transistor and a second plate connected to a first node; and
a plurality of transistors, each of the plurality of transistors coupled to one or more of the drive transistor, the light-emitting device, and the storage capacitor; and performing, using one or more of the plurality of transistors:
an initialization phase comprising setting at least the gate terminal of the drive transistor to a first voltage without turning the drive transistor on by electrically connecting at least the gate terminal of the drive transistor to the first power supply;
a combined threshold compensation and data programming phase to compensate a threshold voltage of the drive transistor and program a data voltage to the pixel circuit by diode-connecting the drive transistor by electrically connecting the first terminal and the gate terminal of the drive transistor, electrically disconnecting the first power supply from the diode-connected drive transistor, electrically disconnecting the second terminal of the drive transistor from the first node, electrically connecting the second terminal of the drive transistor to a preset voltage input line, and electrically connecting a data voltage input line to the second plate of the storage capacitor at the first node;
a continued threshold compensation phase to continue compensating the threshold voltage of the drive transistor without the data voltage input line being connected to the pixel circuit by electrically disconnecting the data voltage input line from the second plate of the storage capacitor without changing any other connections from the combined threshold compensation and data programming phase; and
an emission phase during which light is emitted from the light-emitting device by electrically disconnecting the preset voltage input line from the drive transistor, electrically disconnecting the diode-connection of the drive transistor, electrically connecting the first node to the second terminal of the drive transistor, and electrically connecting the first terminal of the drive transistor to the first power supply.

12. The method of claim 11, further comprising:
electrically disconnecting the second terminal of the drive transistor from the first terminal of the light-emitting device prior to the initialization phase; and
electrically connecting the second terminal of the drive transistor to the first terminal of the light-emitting device after the initialization phase and prior to the combined threshold compensation and data programming phase.

13. The method of claim 11, further comprising:
electrically disconnecting the first terminal of the drive transistor from the first power supply at an end of the emission phase and before the initialization phase; and
electrically connecting the first terminal of the drive transistor to the first power supply after the initialization phase and prior to the combined threshold compensation and data programming phase.

14. The method of claim 11, further comprising:
electrically connecting the second terminal of the drive transistor to a reference voltage input line after the continued threshold compensation phase; and
electrically disconnecting the second terminal of the drive transistor from the reference voltage input line during the emission phase.

15. The method of claim 11, the pixel circuit further comprising a stabilizing capacitor comprising a first plate connected to the first terminal of the drive transistor and a second plate connected to a stabilization voltage input line.

16. The method of claim 11, further comprising:
electrically disconnecting the first terminal of the light-emitting device from a remainder of the pixel circuit during the continued threshold compensation phase; and
electrically connecting the first terminal of the light-emitting device to the second terminal of the drive transistor during the emission phase.

17. The method of claim 11, where the pixel circuit further comprises a second storage capacitor comprising a first plate connected to the gate terminal of the drive transistor and a second plate connected to the second terminal of the drive transistor.

18. A method of operating a pixel circuit for a display device in a low-frequency mode, the method comprising:
providing a pixel circuit comprising:
a drive transistor comprising a gate terminal, a first terminal, and a second terminal, the drive transistor configured to control an amount of current from a first power supply to a light-emitting device depending upon a voltage input applied to the gate terminal of the drive transistor,
the light-emitting device comprising a first terminal electrically connected to a second terminal of the drive transistor and a second terminal electrically connected to a second power supply;
a storage capacitor comprising a first plate connected to the gate terminal of the drive transistor and a second plate connected to a first node; and
a plurality of transistors, each of the plurality of transistors coupled to one or more of the drive transistor, the light-emitting device, and the storage capacitor; and performing, using one or more of the plurality of transistors:
an anode reset phase by electrically connecting a data voltage input line or a preset voltage input line to the second plate of the storage capacitor and the first terminal of the light-emitting device;
an on-bias stress phase by electrically disconnecting the first terminal of the drive transistor from the first power supply, electrically disconnecting the second terminal of the drive transistor from the first node, electrically disconnecting the first node from the data voltage input line, and electrically connecting the second terminal of the drive transistor to the preset voltage input line; and
an emission phase by electrically disconnecting the second terminal of the drive transistor from the preset voltage input line, electrically connecting the second terminal of the drive transistor to the first node, and electrically connecting the first terminal of the drive transistor to the first power supply.

19. The method of claim 18, further comprising:
electrically disconnecting the second terminal of the drive transistor from the first node before the anode reset phase;
electrically disconnecting the first terminal of the light-emitting device from a remainder of the pixel circuit before the on-bias stress phase; and
electrically connecting the first terminal of the light-emitting device to the second terminal of the drive transistor after the on-bias stress phase and before the emission phase.
